(19) United States
(12) Patent Application Publication
(10) Pub. No.: US 2026/0276003 A1
(43) Pub. Date: Sep. 17, 2026

(54) FAN MODULE

(71) Applicant: Shenzhen Jisu Technology Co., Ltd., SHENZHEN (CN)

(72) Inventors: Guanzheng ZHENG, SHENZHEN (CN); Shuiyong YUAN, SHENZHEN (CN); Jiaqi LI, SHENZHEN (CN); Yinggai YANG, SHENZHEN (CN); Wenpeng QI, SHENZHEN (CN)

(21) Appl. No.: 19/680,713

(22) Filed: May 18, 2026

Related U.S. Application Data
(63) Continuation of application No. PCT/CN2024/133259, filed on Nov. 20, 2024.

(30) Foreign Application Priority Data
Nov. 21, 2023 (CN) 202323151697.6
Nov. 21, 2023 (CN) 202323153987.4
Mar. 27, 2024 (CN) 202420621044.5
Mar. 27, 2024 (CN) 202420622073.3
May 20, 2024 (CN) 202421110447.X
May 28, 2024 (CN) 202421200731.6
May 28, 2024 (CN) 202421201601.4

(51) Int. Cl. F04D 29/54; F04D 19/00; F04D 25/08; F04D 29/32; F04D 29/70; F21V 33/00

(52) U.S. Cl. CPC F04D 29/541; F04D 19/002; F04D 25/08; F04D 29/329; F04D 29/703; F21V 33/0096

(57) ABSTRACT

A fan module includes: a fan housing, arranged with an air inlet structure and an air outlet corresponding to the air inlet structure; a fan assembly, arranged inside the fan housing and configured to push an airflow to flow from the air inlet structure toward the air outlet; and an airflow increasing ring, connected to the fan housing, wherein the airflow increasing ring surrounds and covers the air outlet.

### CROSS REFERENCE TO RELATED APPLICATIONS

The present application is a continuation application of the international patent application No. PCT/CN2024/133259, filed on Nov. 20, 2024, which claims priorities of: the Chinese patent application No. 202323153987.4, filed on Nov. 21, 2023; the Chinese patent application No. 202323151697.6, filed on Nov. 21, 2023; the Chinese patent application No. 202420621044.5, filed on Mar. 27, 2024; the Chinese patent application No. 202420622073.3, filed on Mar. 27, 2024; the Chinese patent application No. 202421110447.X, filed on May 20, 2024; the Chinese patent application No. 202421200731.6, filed on May 28, 2024; the Chinese patent application No. 202421201601.4, filed on May 28, 2024; contents of which are incorporated herein by its entireties.

### TECHNICAL FIELD

Embodiments of the present disclosure relate to the technical field of fans, and more specifically, to a fan module.

### BACKGROUND

In hot summer, fans are essential items for people to relieve heat. As users demand fans being used conveniently, lighter and more portable fans are increasingly favored by the users.

A fan in the prior art may include: a housing and a fan assembly. The housing may define an air inlet and an air outlet. The fan assembly may rotate to push external air to flow from the air inlet toward the air outlet, producing an airflow blowing effect. The applicant of the present application has found in research that a fan in the art may drive only the airflow that flows through an interior of the fan, and cannot drive external air to flow directionally, resulting in a relatively low airflow outputting efficiency.

### SUMMARY

The present disclosure provides a fan module capable of driving external air to move directionally, such that the airflow outputting efficiency of the fan may be improved.

The present disclosure provides a fan module, including:
A fan housing, arranged with an air inlet structure and an air outlet corresponding to the air inlet structure;
A fan assembly, arranged inside the fan housing and configured to push an airflow to flow from the air inlet structure toward the air outlet;
An airflow increasing ring, connected to the fan housing, wherein the airflow increasing ring surrounds and covers the air outlet.

### BRIEF DESCRIPTION OF THE DRAWINGS

The above and/or additional aspects and advantages of the present disclosure will become apparent and easily understood based on description of embodiments in combination with the accompanying drawings.

FIG. 1 is an overall structural schematic view of a fan module according to an embodiment 1 of the present disclosure.

FIG. 2 is a cross-sectional view of the fan module according to the embodiment 1 of the present disclosure.

FIG. 3 is a front perspective view of a connecting member according to the embodiment 1 of the present disclosure.

FIG. 4 is a rear perspective view of the connecting member according to the embodiment 1 of the present disclosure.

FIG. 5 is a perspective schematic view of an airflow increasing cover according to the embodiment 1 of the present disclosure.

FIG. 6 is an overall structural schematic view of a fan module according to an embodiment 2 of the present disclosure.

FIG. 7 is an exploded schematic view of a first housing according to the embodiment 2 of the present disclosure.

FIG. 8 is an exploded schematic view of a second housing according to the embodiment 2 of the present disclosure.

FIG. 9 is a cross-sectional view of the fan module according to the embodiment 2 of the present disclosure.

FIG. 10 is a cross-sectional view of connection between a connection plate and a fan assembly according to the embodiment 2 of the present disclosure.

FIG. 11 is a perspective schematic view of a connecting member according to the embodiment 2 of the present disclosure.

FIG. 12 is a perspective schematic view of a first airflow concentrating cover according to the embodiment 2 of the present disclosure.

FIG. 13 is a perspective schematic view of a second airflow concentrating cover according to the embodiment 2 of the present disclosure.

FIG. 14 is a structural schematic view of a hub and blades according to an embodiment 3 of the present disclosure.

FIG. 15 is a structural schematic view of the hub, blades, directions, and angles according to the embodiment 3 of the present disclosure.

FIG. 16 is an overall structural schematic view of fan blades according to an embodiment 4 of the present disclosure.

FIG. 17 is a structural schematic view of the fan blades, being viewed from a first viewing angle, according to the embodiment 4 of the present disclosure.

FIG. 18 is a cross-sectional view of the fan blades according to the embodiment 4 of the present disclosure.

FIG. 19 is a structural schematic view of a hub and blades according to the embodiment 4 of the present disclosure.

FIG. 20 is a structural schematic view of the hub, the blades, directions, and angles according to the embodiment 4 of the present disclosure.

FIG. 21 is an overall structural schematic view of a fan according to an embodiment 5 of the present disclosure.

FIG. 22 is an overall structural schematic view of a base, a swing component, and a connecting rod according to the embodiment 5 of the present disclosure.

FIG. 23 is a top view of structures shown in FIG. 22.

FIG. 24 is a cross-sectional view of a structure shown in FIG. 23, taken along a line A-A.

FIG. 25 is a cross-sectional view of a structure shown in FIG. 23, taken along a line B-B.

FIG. 26 is a cross-sectional view of a support column, an end cover, a rotation bracket, a ball bearing cup, and a fixation ring of the swing component according to the embodiment 5 of the present disclosure.

FIG. 27 is an exploded view of the swing component, the connecting rod, and the base according to the embodiment 5 of the present disclosure.

FIG. 28 is a structural schematic view of the support column, the base, a fixation assembly, and a transmission member according to the embodiment 5 of the present disclosure.

FIG. 29 is a structural schematic view of the support column, the base, a central gear, a locking member, and the transmission member according to the embodiment 5 of the present disclosure.

FIG. 30 is a structural schematic view of the rotation bracket and a limiting member according to the embodiment 5 of the present disclosure.

FIG. 31 is a cross-sectional view of the support column and the limiting member according to the embodiment 5 of the present disclosure.

FIG. 32 is a structural schematic view of a fan connection structure according to an embodiment 6 of the present disclosure.

FIG. 33 is an exploded view of the fan connection structure according to the embodiment 6 of the present disclosure.

FIG. 34 is a structural schematic view of a fan outer cover according to the embodiment 6 of the present disclosure.

FIG. 35 is a structural schematic view of a connecting shaft according to the embodiment 6 of the present disclosure.

FIG. 36 is a cross-sectional view of the fan connection structure shown in FIG. 32, taken along a line A-A, according to the embodiment 6 of the present disclosure.

FIG. 37 is an enlarged view of a portion B in FIG. 36 according to the embodiment 6 of the present disclosure.

FIG. 38 is a structural schematic view of a bracket according to the embodiment 6 of the present disclosure.

FIG. 39 is a structural schematic view of a base housing according to the embodiment 6 of the present disclosure.

FIG. 40 is an exploded view of a fan swing component according to an embodiment 7 of the present disclosure.

FIG. 41 is an assembled view of the fan swing component according to the embodiment 7 of the present disclosure.

FIG. 42 is a structural schematic view of the fan swing component shown in FIG. 40, taken along a line A-A, according to the embodiment 7 of the present disclosure.

FIG. 43 is a partial structural schematic view I of the fan swing component according to the embodiment 7 of the present disclosure.

FIG. 44 is a partial structural schematic view II of the fan swing component according to the embodiment 7 of the present disclosure.

FIG. 45 is a partial structural schematic view III of the fan swing component according to the embodiment 7 of the present disclosure.

FIG. 46 is a partial structural schematic view IV of the fan swing component according to the embodiment 7 of the present disclosure.

FIG. 47 is a partial structural schematic view V of the fan swing component according to the embodiment 7 of the present disclosure.

FIG. 48 is a cross-sectional view of the fan swing component shown in FIG. 47, taken along a line B-B, according to the embodiment 7 of the present disclosure.

FIG. 49 is a structural schematic view of a second bearing according to the embodiment 7 of the present disclosure.

### DETAILED DESCRIPTIONS

### Embodiment 1

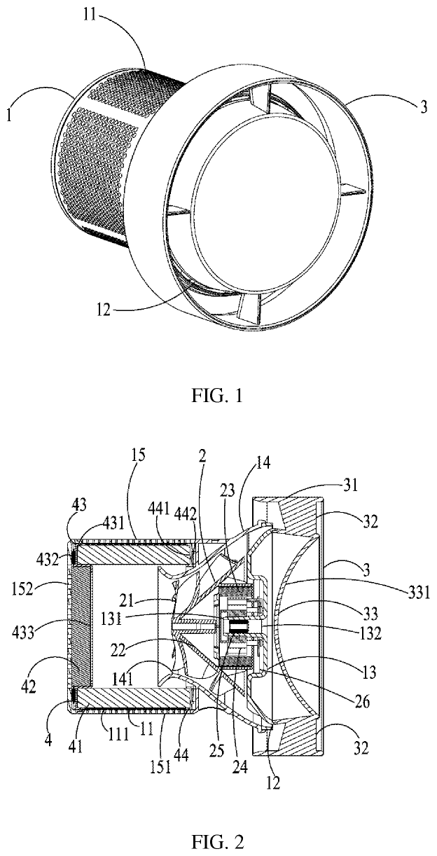

FIG. 1 is an overall structural schematic view of a fan module according to the present embodiment.

As shown in FIG. 1, a fan module may include: a fan housing 1, a fan assembly 2, and an airflow increasing ring 3. The fan housing 1 may be arranged with an air inlet structure 11 and an air outlet 12 corresponding to the air inlet structure 11. The fan assembly 2 may be arranged inside the fan housing 1 and may be configured to push an airflow from the air inlet structure 11 toward the air outlet 12. The airflow increasing ring 3 may be connected to the fan housing 1, and the airflow increasing ring 3 may surround and cover the air outlet 12.

In the above implementation, the fan assembly 2 may rotate to push the airflow, which has entered the fan housing 1, from the air inlet structure 11 toward the air outlet 12. After the airflow flows out of the air outlet 12, the airflow may have an initial kinetic energy, and the airflow having the initial kinetic energy may drive air in contact with the airflow to flow. At this moment, the airflow flowing out of the air outlet 12 may enter the airflow increasing ring 3, and the airflow in the airflow increasing ring 3 may create a flow difference, such that a negative pressure may be generated inside the airflow increasing ring 3. Under the atmospheric pressure, an airflow located behind the airflow increasing ring 3 may flow into the airflow increasing ring and may be driven by the airflow output from the air outlet 12 to flow. In this way, an airflow strength of the fan module may be increased, the amount of airflow output from the fan may be increased, and an airflow outputting efficiency of the fan may be increased.

FIG. 2 is a cross-sectional view of the fan module according to the present embodiment.

As shown in FIG. 2, the fan housing 1 may include a first housing 15 and an airflow guide cover 14. The first housing 15 may be connected to the airflow guide cover 14. A connecting member 13 may be connected to the airflow guide cover 14. The fan assembly 22 may extend to an inside of the airflow guide cover 14. The airflow guide cover 14 may be arranged with a constricted port 141. The fan assembly 21 may be disposed between the constricted port 141 and the connecting member 13.

The fan housing 1 may be connected to the connecting member 13. The air outlet 12 may be defined in the connecting member 13. The fan assembly 2 may be connected to the connecting member 13. The airflow increasing ring 3 may be connected to the connecting member 13.

The fan housing 1 and the connecting member 13 may be connected to each other via snap-fit connection. However, a connection manner therebetween may not be limited thereto. Depending on specific application scenarios, in some embodiments, the fan housing 1 and the connecting member 13 may be connected to each other via adhesive bonding, riveting, screws, or the like.

In some embodiments, the connection between the fan housing 1 and the connecting member 13 may be that the fan housing 1 and the connecting member 13 are integrally formed with each other during manufacturing. In the present embodiment, due to a manufacturing process, the fan housing 1 and the connecting member 13 may not be significantly distinct from each other. Each of the fan housing 1 and the connecting member 13 may be determined based on a function thereof.

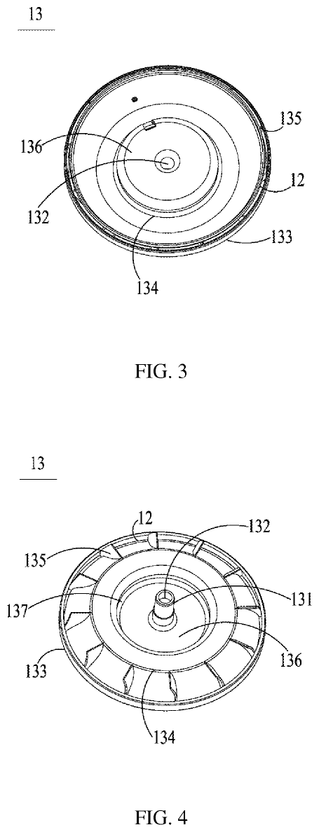

As shown in FIGS. 3 and 4, FIG. 3 is a front perspective view of the connecting member according to the present embodiment; and FIG. 4 is a rear perspective view of the connecting member according to the present embodiment.

As shown in FIGS. 3 and 4, the connecting member 13 may include: a connecting ring 133, a first cover body 134, and a plurality of airflow guide plates 135. The connecting ring 133 may be connected to an inner surface of the fan housing 1. The plurality of airflow guide plates 135 may be distributed around the first cover body 134 along a circumferential direction of the first cover body 134. One end of each of the plurality of airflow guide plate 135 may be connected to the first cover body 134, and the other end of each airflow guide plate 135 may be connected to the connecting ring 133. The fan assembly 2 may be connected to the first cover body 134. The connecting ring 133 and the first cover body 134 may cooperatively define the air outlet 12, and the air outlet 12 may be annular.

The connecting ring 133 may be connected to the first housing 15. A connection manner therebetween may be (but not limited to): adhesive bonding, snap-fitting, screwing.

In the present embodiment, the number of the plurality of airflow guide plates 135 may be 12. However, the number of the plurality of airflow guide plates 135 may not be limited thereto. Depending on specific application scenarios, in some implementations, the number of the plurality of airflow guide plates 135 may be (but not limited to): 2, 3, 6, 7, 8, 10, 13, or more.

The connecting ring 133 and the first cover body 134 may cooperatively define the air outlet 12, which may be annular and slit. The annular slit air outlet 12 may allow the airflow at the air outlet 12 to have a higher initial velocity, and the airflow may be more concentrated. Furthermore, the higher initial velocity may enable the airflow to create a greater velocity difference within the airflow increasing ring 3, such that a greater negative pressure may be generated, and an airflow-increasing amount of the airflow increasing ring 3 may be increased.

Along an airflow outputting direction of the air outlet 12, a distance between the first cover body 134 and the fan housing 1 may gradually decrease, a distance between the first cover body 134 and the connecting ring 133 may gradually decrease, and a width of each airflow guide plate 135 may gradually decrease. Considering that the distance between the first cover body 134 and the fan housing 1 gradually decreases and the distance between the first cover body 134 and the connecting ring 133 gradually decreases, a space of an airflow channel inside the fan module may gradually decrease. In this way, the airflow flowing through the interior of the fan module may be gradually pressurized, such that the initial velocity of the airflow at the air outlet 12 may be increased, and a uniform pressurization process may avoid an energy loss of the airflow caused by a sudden space reduction. Therefore, a structure in which the distance gradually decreases may allow the airflow at the air outlet 12 to be more concentrated and have the higher initial velocity, such that the greater negative pressure may be generated, and a more obvious airflow increasing effect may be achieved.

In a direction extending from the air outlet 12 toward the air inlet structure 11, each airflow guide plate 135 may extend curved along a surface of the first cover body 134. A curved direction of each airflow guide plate 135 may be opposite to a rotation direction of the fan assembly 2 during rotation. The curved direction of the airflow guide plate 135 may be opposite to the rotation direction of the fan assembly 2. When the fan assembly 2 rotates, an airflow, which rotates in a direction same as the rotation direction of the fan assembly 2, may be generated. When the rotating airflow contacts the airflow guide plates 135, since each airflow guide plate 135 is curved in the opposite direction, a contact angle between the airflow guide plate 135 and the rotating airflow may be an obtuse angle, such that a kinetic energy loss of the airflow when contacting the airflow guide plates 135 may be reduced, and a guiding efficiency in which the airflow guide plates 135 guide the airflow may be improved.

In some implementations, the connecting ring 133 and the fan housing 1 may be manufactured by being integrally molded with each other.

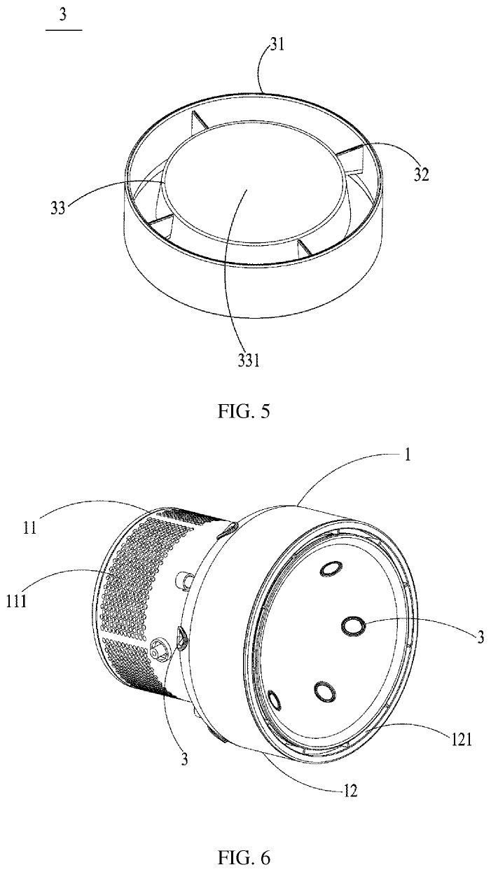

FIG. 5 is a perspective schematic view of the airflow increasing cover according to the present embodiment.

As shown in FIG. 5, a side of the first cover body 134 facing the airflow increasing ring 3 may be protruding to form a connection plate 136. A side of the connection plate 136 facing the fan assembly 2 may be arranged with a connection post 131, and the fan assembly 2 may be connected to the connection post 131.

The fan assembly 2 may include: fan blades, a magnetic ring 23, a coil 24, and a rotation shaft (not shown). The fan blades may be sleeved on the magnetic ring 23. The magnetic ring 23 may be sleeved on the coil 24. One end of the rotation shaft may be connected to the fan blades. The connection post 131 may define an assembly hole 132 penetrating the connection post 131. The coil 24 may be sleeved on the connection post 131. The other end of the rotation shaft may pass through the coil 24 and the magnetic ring 23 to be inserted into the assembly hole 132.

The sleeved connection among the fan blades, the magnetic ring 23, the coil 24, and the connection post 131 may greatly reduce a size of the fan assembly 2. The connection manner between the assembly hole 132 and the rotation shaft may further reduce an exposed size of the fan assembly, such that the fan assembly may be smaller in size.

The coil 24 and the connection post 131 may be in an interference fit with each other. However, the connection manner between the coil 24 and the connection post 131 may not be limited thereto. Depending on specific application scenarios, in some implementations, the connection manner between the coil 24 and the connection post 131 may be (but not limited to): adhesive bonding, snap-fitting, or bolt fixing.

A shaft sleeve 25 and a circlip may be arranged in the assembly hole 132. The end of the rotation shaft inserted into the assembly hole 132 may pass through the shaft sleeve 25 and may be connected to the circlip. The coil 24 may be sleeved on the connection post 131 at a position where the shaft sleeve 25 is arranged.

The assembly hole 132 and the shaft sleeve 25 may be in an interference fit with each other. However, the connection manner between the assembly hole 132 and the shaft sleeve 25 may not be limited thereto. Depending on specific application scenarios, in some implementations, the connection manner between the shaft sleeve 25 and the assembly hole 132 may be (but not limited to): adhesive bonding or snap-fitting.

By arranging the shaft sleeve 25 in the assembly hole 132 and arranging the rotation shaft to pass through the shaft sleeve 25, the rotation shaft may rotate more smoothly.

The coil 24 may be sleeved on the connection post 131 at the position where the shaft sleeve 25 is arranged. Since the shaft sleeve 25 may support the connection post 131, the position where the shaft sleeve 25 is arranged may have greater physical strength. The coil 24 and the connection post 131 may be in the interference fit with each other. As the physical strength is greater, an allowable connection pressure between the coil 24 and the connection post 131 may be greater, such that connection between the coil 24 and the connection post 131 may be more stable.

The fan blades may include: a hub 22 and a plurality of blades 21. The hub 22 may be sleeved on the magnetic ring 23, and the hub 22 may be connected to one end of the rotation shaft.

In the present embodiment, the hub 22 may be conical. However, a shape of the hub 22 may not be limited thereto. Depending on specific application scenarios, in some implementations, the hub 22 may be (but not limited to): hemispherical, truncated conical, or cylindrical.

In the present embodiment, each of the plurality of blades 21 may extend, vertically or obliquely or curvedly or spirally, from a bottom end of the hub 22 toward a top end of the hub 22 along a surface of the hub 22.

In the present embodiment, the number of the plurality of blades 21 may be two or more.

The side of the connection plate 136 facing the fan assembly 2 may be recessed inward to form a receiving ring 137. The receiving ring 137 may surround the connection post 131. At least part of the fan assembly 2 may extend into the receiving ring 137. By arranging the receiving ring 137 to allow the fan assembly 2 to extend into the receiving ring 137, the fan module may be assembled to form a more compact structure. In addition, exposed structures may be reduced, air resistance inside the fan module may be reduced, and the airflow outputting efficiency may be improved.

The fan assembly 2 may further include a PCB circuit board 26. The PCB circuit board 26 may be fixed to the coil 24 by screws, or may be connected to the coil 24 via a bracket (not shown). The PCB circuit board 26 may define a through hole. The PCB circuit board 26 may be sleeved on the connection post 131 via the through hole.

In some implementations, the PCB circuit board 26 may extend into the receiving ring 137. However, a relative relationship between the fan assembly 2 and the receiving ring 137 may not be limited thereto. Depending on specific application scenarios, in some implementations, the coil 24 or part of the coil 24 may also extend into the receiving ring 137.

In some implementations, the fan assembly 2 may include: blades and a motor. The motor may be connected to the connecting member 13. The motor may be arranged with a rotation shaft, and the blades may be connected to the rotation shaft.

The airflow increasing ring 3 may include: a first ring body 31, an airflow increasing plate 33, and a plurality of connecting plates 32. The airflow increasing plate 33 may be connected to the connecting member 13. The plurality of connecting plates 32 may be distributed around the airflow increasing plate 33 along a circumferential direction of the airflow increasing plate 33. One end of each connecting plate 32 may be connected to the airflow increasing plate 33, and the other end of each connecting plate 32 may be connected to the first ring body 31.

In the present embodiment, a diameter of the first ring body 31 may be greater than a diameter of the air outlet 12. In this way, the airflow blown out from the air outlet 12 may drive other airflow within the first ring body 31 to flow, such that a velocity difference may be generated, and a negative pressure may be formed.

A side of the airflow increasing plate 33 facing the connecting member 13 may be recessed inward to form a curved surface 331. The airflow increasing plate 33 may be disposed at a middle region of the air outlet. When the air outlet 12 outputs the airflow, a vortex may be generated at a position where the airflow increasing plate 33 is arranged and along an extension path of the airflow increasing plate 33. By arranging the surface of the airflow increasing plate 33 as the curved surface 331, the generated vortex may flow along the curved surface 331 to re-enter an airflow outputting region of the air outlet 12 with a lower air resistance. Therefore, by arranging the curved surface 331, the air resistance of the airflow vortex generated at the middle region of the air outlet 12 may be reduced, allowing the airflow vortex to enter an airflow outputting path with less energy loss, such that the airflow outputting efficiency may be improved. Furthermore, due to a guiding effect of the curved surface 331, the generated airflow vortex may directionally enter the airflow outputting path, rather than interfering with the normal output airflow as a turbulent flow, such that the airflow outputting efficiency may be improved.

Along the airflow outputting direction of the air outlet 12, a width of the first ring body 31 may be greater than a width of the airflow increasing plate 33. Along the airflow outputting direction, the width of the first ring body 31 may be greater than the width of the airflow increasing plate 33, such that the first ring body 31 may completely cover the airflow increasing plate 33 in the airflow outputting direction. In this way, the airflow blown out from the air outlet 12 may completely enter the airflow increasing ring 3, escaping of the airflow blown out of the air outlet 12 before entering the airflow increasing ring 3, caused by insufficient width of the airflow increasing ring 3, may be avoided, the airflow outputting efficiency may not be reduced.

The air inlet structure 11 may include a plurality of air inlet holes 111. The plurality of air inlet holes 111 may be defined in the first housing 15. The air inlet holes 111 may be defined in a side edge 151 and a bottom surface 152 of the first housing 15. However, the air inlet structure 11 may not be limited thereto. Depending on specific application scenarios, in some implementations, the air inlet structure 11 may be an air inlet port formed on the housing bottom surface 152, or an air inlet groove formed on the side edge 151 of the housing, or an air inlet groove formed on the housing bottom surface 152, and so on.

A filter assembly 4 may be arranged in the first housing 15, and a filter member may cover the air inlet holes 111. The filter assembly 4 may be a sheet or pleated sheet made of filter material. The filter member may be arranged inside the first housing 15 and may cover an inner surface of the first housing 15 where ventilation holes are formed. In this way, air entering the first housing 15 may be filtered, and air quality of the airflow at the air outlet 12 may be improved.

A gap may be formed between the first housing 15 and an end of the airflow guide cover 14 facing away from the connecting member 13. A reinforcing rib may be arranged in the gap. One end of the reinforcing rib may be connected to the first housing 15, and the other end of the reinforcing rib may be connected to the airflow guide cover 14. One end of the filter member may be inserted into the gap and connected to the reinforcing rib. By arranging the reinforcing rib, connection strength between the first housing 15 and the airflow guide cover 14 may be improved. In the present embodiment, the reinforcing rib may be annular. By inserting the filter member into the gap between the first housing 15 and the airflow guide cover 14, the airflow may be prevented from re-entering the gap between the first housing 15 and the airflow guide cover 14 to form the vortex, such that the airflow outputting efficiency of the fan module may be improved.

The airflow guide cover 14 may be arranged with the constricted port 141. The constricted port 141 may prevent the airflow that has entered the airflow guide cover from flowing reversely after contacting the blades 211, such that the airflow outputting efficiency may be improved.

The filter member may include: a first mounting ring 43, a second mounting ring 44, a filter ring 41, and a filter sheet 42. The filter ring 41 may be connected to the first mounting ring 43 and the second mounting ring 44. The filter sheet 42 may be connected to the first mounting ring 43. The second mounting ring 44 may be received in the gap and connected to the reinforcing rib. The first mounting ring 43 may be connected to the bottom surface of the first housing 15. The first mounting ring 43 and the second mounting ring 44 may serve as the connecting member 13 for connecting the filter ring 41 and the filter sheet 42 to the first housing 15, such that an assembly efficiency of the filter assembly 4 may be improved.

The first mounting ring 43 may define a first mounting groove 431 and an annular storage cavity 433. The first mounting groove 431 may surround the annular storage cavity 433. The second mounting ring 44 may define a second mounting groove 441. One end of the filter ring 41 may be inserted into the first mounting groove 431, and the other end of the filter ring 41 may be inserted into the second mounting groove 441. The filter sheet 42 may be received in the annular storage cavity 433. By arranging the grooves and the cavities, the first mounting ring 43 and the second mounting ring 44 may be adaptive to shapes of the filter ring 41 and the filter sheet 42 to achieve the connection, increasing connection strength with the filter ring 41 and the filter sheet 42, and air tightness at connection positions may be improved.

The first mounting ring 43 may further define a first connection groove 432. An opening direction of the first connection groove 432 may be opposite to an opening direction of the first mounting groove 431. An opening of the first connection groove 432 may face the bottom surface 152 of the housing. A connecting adhesive may be arranged in the first connection groove 432 and may connect the first mounting ring 43 to the housing bottom surface 152.

The second mounting ring 44 may further define a second connection groove 442. An opening direction of the second connection groove 442 may be opposite to an opening direction of the second mounting groove 441. An opening of the second connection groove 442 may face the reinforcing rib. A connecting adhesive may be arranged in the second connection groove 442 and may connect the second mounting ring 44 to the reinforcing rib.

A lamp cover (not shown) may be arranged on the airflow increasing ring. The lamp cover may be arranged on the inner surface of the airflow increasing ring. However, a position of the lamp cover may not be limited thereto. Depending on specific application scenarios, in some implementations, the lamp cover may be disposed on side edges of two ends of the airflow increasing ring or on an outer surface of the airflow increasing ring.

A light-emitting body may be arranged inside the lamp cover. The light-emitting body may be (but not limited to): a LED lamp bead, a LED light strip, or a bulb, and so on.

The fan module arranged with the lamp cover may provide illumination for the user while blowing the airflow. Especially in an environment with a high temperature and requiring supplemental light, multiple functions may be achieved by one device, and usage convenience may be improved.

### Embodiment 2

FIG. 6 is an overall structural schematic diagram of the fan module according to the present embodiment.

As shown in FIG. 6, the fan module may include: a fan housing 1, a fan assembly 4, and an airflow increasing tube 3. The fan housing 1 may be arranged with the air inlet structure 111 and the air outlet 121 corresponding to the air inlet structure 111. The fan assembly 4 may be arranged inside the fan housing 1 and configured to push the airflow from the air inlet structure 111 toward the air outlet 121. The airflow increasing tube 3 may be arranged on the fan housing 1. One end of the airflow increasing tube 3 may be defined in a negative pressure region created by the airflow output from the air outlet 121, and the other end of the airflow increasing tube 3 may be defined in a surface of the fan housing 1.

In the above implementation, the fan assembly 4 may rotate to push the airflow that has entered the fan housing 1 from the air inlet structure 111 toward the air outlet 121. After flowing out of the air outlet 121, the airflow may have the initial kinetic energy, and the airflow with the initial kinetic energy may drive other air in contact with it to flow. At this moment, surrounding air near the air outlet 121 may flow as the airflow with the initial kinetic energy moves, creating the negative pressure region. After the negative pressure region is created, the surrounding air may flow toward the negative pressure region, and a resulting turbulent flow may affect the efficiency of the airflow blown out from the air outlet 121. By arranging the airflow increasing tube 3 on the fan housing 1, one end of the airflow increasing tube 3 may be arranged on the surface of the fan housing 1, and the other end may be arranged in the negative pressure region created by the airflow from the air outlet 121. External air may flow directionally through the airflow increasing tube 3 toward the negative pressure region. The directionally flowing airflow may not create the turbulent flow that affects the airflow blown out from the air outlet 121, and may drive external air to flow directionally. In this way, an airflow force of the fan may be improved, and the airflow outputting efficiency may be improved in two ways.

The fan housing 1 may include: a first housing 11 and a second housing 12. The first housing 11 and the second housing 12 may be connected to each other. The air inlet structure 111 may be arranged on the first housing 11. The air outlet 121 may be arranged on the second housing 12. The fan assembly 4 may be arranged inside the first housing 11 and/or the second housing 12. The airflow increasing tube 3 may be arranged on the second housing 12.

In some implementations, the first housing 11 and the second housing 12 may be integral formed with each other. In the present implementation, the fan housing 1 may be one integral piece.

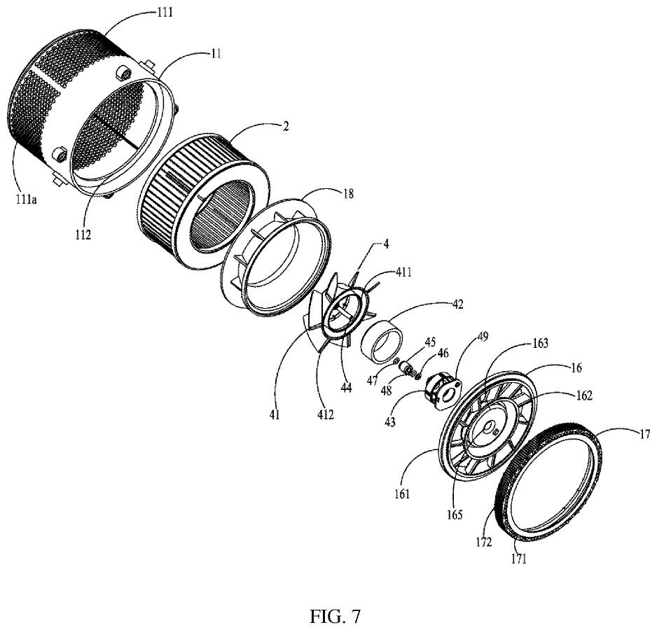

FIG. 7 is an exploded schematic view of the first housing according to the present embodiment.

As shown in FIG. 7, in some implementations, the fan assembly 4 may be arranged in the first housing 11. However, a position of the fan assembly 4 may not be limited thereto. Depending on specific application scenarios, in some implementations, the fan assembly 4 may be arranged inside the second housing 12 or may be arranged between the first housing 11 and the second housing 12. By arranging the air inlet structure 111 on the first housing 11 and arranging the airflow

increasing tube 3 on the second housing 12, the air inlet structure 111 and the airflow increasing tube 3 may be disposed far apart from each other, avoiding mutual interference between the air inlet structure 111 and the airflow increasing tube 3 during air intake, and an air intaking efficiency of each of the air inlet structure 111 and the airflow increasing tube 3 may be improved.

Along an airflow outputting direction of the air outlet 121, a cross-sectional area of the second housing 12 may be greater than a cross-sectional area of the first housing 11. The first housing 11 and the second housing 12 may form a stepped structure. The second housing 12 may be disposed at a lower end of the stepped structure, and the first housing 11 may be disposed at an upper end of the stepped structure. The cross-sectional area of the second housing 12 may be greater than a cross-sectional area of the first housing 11. Configuration of the first housing 11 and the second housing 12 may effectively prevent the airflow increasing tube 3 and the air inlet structure 11 from intaking air in a same space, such that mutual interference may be prevented. Since the airflow increasing tube 3 is arranged on the second housing 12 and the cross-sectional area of the second housing 12 is greater than that of the first housing 11, compared to the position of the air inlet structure 111, the airflow increasing tube 3 may have a broader air source and may be less likely to interfere with the air inlet structure 111.

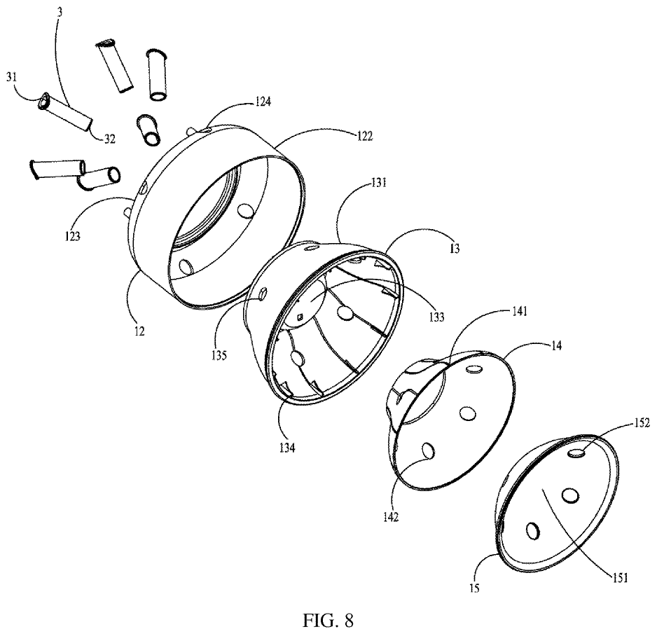

FIG. 8 is an exploded schematic view of the second housing according to the present embodiment.

As shown in FIG. 8, the second housing 12 may include: a housing side edge 122 and a housing bottom surface 123. The housing side edge 122 and the housing bottom surface 123 may be connected to each other, and a transition therebetween may be smooth. The housing bottom surface 123 may be connected to the first housing 11. One end of the first cover body 131 may be connected to the housing bottom surface 123, and the other end of the first cover body 131 may be connected to the housing side edge 122. The end of the airflow increasing tube 3 that is arranged on the second housing 12 may be disposed at the transition position between the housing side edge 122 and the housing bottom surface 123.

By disposing the end of the airflow increasing tube 3 for intaking air at the transition position between the housing side edge 122 and the housing bottom surface 123, a greater spatial distance may be formed between an air intaking space of the airflow increasing tube 3 and an air intaking space of the air inlet structure 111, avoiding three-dimensional spatial interference between the air intaking space of the airflow increasing tube 3 and the air intaking space of the air inlet structure 111. The air intaking efficiency of each of the airflow increasing tube 3 and the air inlet structure 111 may be improved.

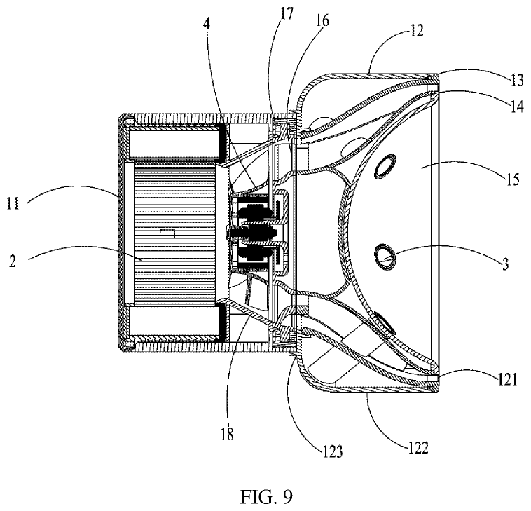

FIG. 9 is a cross-sectional view of the fan module according to the present embodiment.

As shown in FIG. 9, the fan module may further include: a connecting member 16. The connecting member 16 may be connected inside the first housing 11. The fan assembly 4 may be connected to the connecting member 16. By arranging the connecting member 16, the fan assembly 4 may be suspended inside the fan housing 1, such that a rotation efficiency of the fan assembly 4 may be improved.

In some implementations, the connecting member 16 may be arranged inside the second housing 12, or the connecting member 16 may be disposed between the first housing 11 and the second housing 12.

In some implementations, the connecting member 16 may be integrally formed with the fan housing 1.

The connecting member 16 may include: a connecting ring 161, a connection plate 163, and a plurality of first airflow guide plates 162. The connecting ring 161 may be connected to an inner surface of the first housing 11. The plurality of first airflow guide plates 162 may be arranged surrounding the connection plate 163. One end of each first airflow guide plate 162 may be connected to the connecting ring 161, and the other end of each first airflow guide plate 162 may be connected to the connection plate 163. The fan assembly 4 may be connected to the connection plate 163.

In some implementations, the connecting ring 161 may be arranged inside the second housing 12, or the connecting ring 161 may be disposed between the first housing 11 and the second housing 12.

In some implementations, the connecting ring 161 may be integrally formed with the fan housing 1. Therefore, in some implementations, the plurality of first airflow guide plates 162 may be directly connected to the inner surface of the fan housing 1.

Configuration of the connecting ring 161, the connection plate 163, and the plurality of first airflow guide plates 162 may allow the connecting member 16 to ensure the fan assembly 4 to be suspended and to guide the airflow inside the fan housing 1.

Each of the plurality of first airflow guide plates 162 may be curved. A curved direction of the first airflow guide plate 162 may be opposite to a rotation direction of the fan assembly 4. A curved direction of a curved end of the first airflow guide plate 162 may be opposite to the rotation direction of the fan assembly 4. In this way, when the first airflow guide plate 162 contacts the airflow, a contact angle between the airflow and the first airflow guide plates 162 may be an obtuse angle greater than 90°. Since the first airflow guide plate 162 is configured to guide the airflow toward the air outlet 121, the contact angle being the obtuse angle may improve an airflow guiding efficiency of the first airflow guide plates 162 and improve the airflow outputting efficiency of the fan module.

FIG. 11 is a perspective schematic view of the connecting member according to the present embodiment.

As shown in FIG. 11, a side of the connection plate 163 facing the air inlet structure 111 may be protruding to form a connection post 164. The fan assembly 4 may be connected to the connection post 164. By arranging the connection post 164 on the connection plate 163, connection between the fan assembly 4 and the connecting member 16 may be achieved more conveniently and faster. The fan module may further include: a buffer ring 17. The buffer ring 17 may be sleeved on the connecting ring 161. The buffer ring 17 may be disposed in a snap-fit space formed by the first housing 11 and the second housing 12.

An annular blocking rim 112 may be arranged inside the first housing 11, and the snap-fit space may be formed between the annular blocking rim 112 and the second housing 12. By arranging the buffer ring 17, vibration and noise generated when the fan assembly 4 rotates may be buffered and eliminated, such that the rotation efficiency of the fan assembly 4 may be improved, and rotation noise of the fan module may be reduced. By disposing the buffer ring 17 between the annular blocking rim 112 and the second housing 12, space utilization may be improved, and the fan module may be more compact in size. Furthermore, the buffer ring 17 may serve as a buffer component between the first housing 11 and the second housing 12, reducing rigid friction generated therebetween.

A surface of the buffer ring 17 may be arranged with anti-slip teeth 172 and/or an anti-slip protrusion 171. In the present embodiment, a side edge of the buffer ring 17 that contacts the inner surface of the second housing 12 may be arranged with the anti-slip teeth 172; and a side face of the buffer ring 17 that contacts the annular blocking rim 112 and the second housing 12 may be arranged with the anti-slip protrusion 171. In some implementations, the surface of the buffer ring 17 may be arranged with the anti-slip protrusion 171 or the anti-slip teeth 172. By arranging the anti-slip teeth 172 and/or the anti-slip protrusion 171, connection stability of the buffer ring 17 may be improved, and a risk of the buffer ring 17 being detached off may be reduced. By arranging the anti-slip teeth 172 and/or the anti-slip protrusion 171, a buffering effect may be achieved in a stepwise manner. Due to arranging the anti-slip teeth 172 and/or the anti-slip protrusion 171, only the anti-slip teeth 172 and/or anti-slip protrusion 171 may be deformed firstly under an initial pressure. Since an area of the anti-slip teeth 172 and/or anti-slip protrusion 171 may be relatively small compared to the entire area of the buffer ring 17, a force that can be withstood may be relatively small, and therefore, a buffering deformation may be in a larger range, such that a better buffering effect may be achieved. When the pressure applied on the anti-slip teeth 172 and/or anti-slip protrusion 171 causes the anti-slip teeth 172 and/or anti-slip protrusion 171 to be attached to the surface of the buffer ring 17, the entire buffer ring 17 may bear the force, being able to withstand a greater buffering force with a smaller deformation space. Combination thereof may provide a better buffering effect.

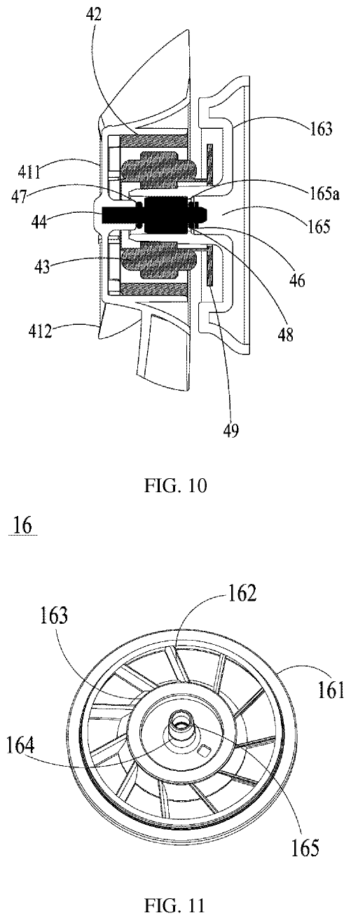

FIG. 10 is a cross-sectional view of the fan module according to the present embodiment.

As shown in FIG. 10, the fan assembly 4 may include: fan blades 41, a magnetic ring 42, a coil 43, and a rotation shaft 44. The fan blades 41 may be sleeved on the magnetic ring 42. The magnetic ring 42 may be sleeved on the coil 43. One end of the rotation shaft 44 may be connected to the fan blades 41. The connection post 164 may define an assembly hole 165 penetrating the connection post 164. The coil 43 may be sleeved on the connection post 164. The other end of the rotation shaft 44 may pass through the coil 43 and the magnetic ring 42 to be inserted into the assembly hole 165.

The sleeved connection among the fan blades 41, the magnetic ring 42, the coil 43, and the connection post 164 may greatly reduce a size of the fan assembly 4. The connection manner between the assembly hole 165 and the rotation shaft 44 may further reduce a size of an exposed part of the fan assembly 4, enabling the fan assembly 4 to be more compact.

The coil 43 and the connection post 164 may be connected to each other in an interference fit manner. However, the connection manner between the coil 43 and the connection post 164 may not be limited thereto. Depending on specific application scenarios, in some implementations, the connection manner between the coil 43 and the connection post 164 may be (but not limited to): adhesive bonding, snap-fitting, or bolt fixing.

A shaft sleeve 45 and a circlip 46 may be arranged in the assembly hole 165. The end of the rotation shaft 44 inserted into the assembly hole 165 may pass through the shaft sleeve 45 and connected to the circlip 46. The coil 43 may be sleeved on the connection post 164 at a position where the shaft sleeve 45 is arranged.

A PCB board 49 may be connected to the coil 43. The PCB board 49 may define a hole, such that the PCB board 49 may be sleeved on the connection post 164. Stacking the coil 43 and the PCB board 49 may enable reasonable usage of space, enabling the fan module to be more compact.

The assembly hole 165 and the shaft sleeve 45 may be in an interference fit with each other. However, the connection between the assembly hole 165 and the shaft sleeve 45 may not be limited thereto. Depending on specific application scenarios, in some implementations, the connection between the shaft sleeve 45 and the assembly hole 165 may be (but not limited to): adhesive bonding or snap-fitting.

By arranging the shaft sleeve 45 in the assembly hole 165 and arranging the rotation shaft 44 to pass through the shaft sleeve 45, the rotation shaft 44 may rotate more smoothly. The coil 43 may be sleeved on the connection post 164 at a position where the shaft sleeve 45 is arranged. The shaft sleeve 45 may support the connection post 164, and therefore, the position where the shaft sleeve 45 is arranged may have a higher physical strength. The coil 43 and the connection post 164 may be in an interference fit with each other. As the physical strength is higher, an allowable connection pressure between the coil 43 and the connection post 164 may be greater, enabling the connection between the coil 43 and the connection post 164 to be more stable.

A first buffer pad 47 and a second buffer pad 48 may be arranged in the assembly hole 165. Both the first buffer pad 47 and the second buffer pad 48 may be sleeved on the rotation shaft 44. The first buffer pad 47 may be disposed between the shaft sleeve 45 and the fan blades 41. The second buffer pad 48 may be disposed between the circlip 46 and the shaft sleeve 45.

Configuration of the first buffer pad 47 and the second buffer pad 48 may effectively prevent physical rubbing between the shaft sleeve 45 and the fan blades 41 and between the shaft sleeve 45 and the circlip 46, such that the service life of the fan assembly 4 may be improved.

A stop member 165a may be protruding in the assembly hole 165. The stop member 165a may abut against the shaft sleeve 45. In the present embodiment, the stop member 165a may be an annular protrusion. However, a structure of the stop member 165a may not be limited thereto. Depending on specific application scenarios, in some implementations, the stop member 165a may be a protruding dot-shaped stop member 165a.

By arranging the stop member 165a, the shaft sleeve 45 may be installed more easily and in a more standardized manner, avoiding an installation position of the shaft sleeve 45 from being deviated, such that difficulties in assembly the shaft sleeve 45 may be reduced, accidental wear of the fan assembly 4 may be avoided.

The fan blades 41 may include: a hub 411 and a plurality of blades 412. The hub 411 may be sleeved on the magnetic ring 42, and the hub 411 may be connected to one end of the rotation shaft 44. The hub may be configured as a truncated cone. The plurality of blades 412 may be distributed on a side edge of the hub 411 along a circumferential direction. Each of the plurality of blades 412 may be inclined along the side edge of the hub 411.

By configuring the hub 411 as the truncated cone, along the air intaking direction of the fan assembly 4, the cross-sectional area of the fan blades 41 may gradually increase, an ability to constrain the airflow may be gradually improved, and the airflow outputting efficiency of the fan blades 41 may be increased.

The number of the plurality of blades 412 in the present embodiment may be two or more. The blade 412 may be inclined along the side edge of the hub 411. Therefore, when the fan blades 41 rotate, a constraining force on the airflow may change linearly, such that the airflow outputting efficiency of the fan blades 41 may be improved.

In some implementations, the fan assembly 4 may further include: a metal ring. The metal ring may be sleeved between the hub 411 and the magnetic ring 42. The metal ring and the magnetic ring 42 may be connected to each other in an interference fit manner. The hub 411 and the metal ring may be connected to each other in an interference fit manner. By arranging the metal ring, the physical strength of the magnetic ring 42 may be improved, preventing the magnetic ring 42 from being fractured due to uneven stress or excessive pressure.

The fan module may further include: a first airflow concentrating cover 13 and a second airflow concentrating cover. The first airflow concentrating cover 13 may be disposed in the second housing 12. The second airflow concentrating cover may be sleeved inside the first airflow concentrating cover 13. The first airflow concentrating cover 13 and the second airflow concentrating cover may cooperatively define the air outlet 121. One end of the airflow increasing tube 3 may be defined in the second housing 12, and the other end of the airflow increasing tube 3 may extend obliquely to pass through the first airflow concentrating cover 13 and the second airflow concentrating cover.

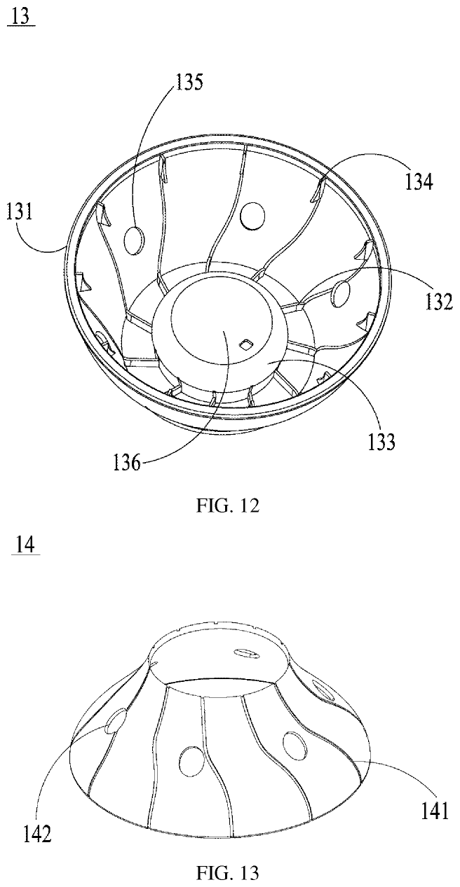

FIG. 12 is a perspective schematic view of the first airflow concentrating cover according to the present embodiment.

As shown in FIG. 12, the air outlet 121 defined by the first airflow concentrating cover 13 and the second airflow concentrating cover may be an annular air outlet 121. Configuration of the annular air outlet 121 may enable an inner region of the air outlet 121 to form the negative pressure region, and a range of the negative pressure region may be more stable. The airflow increasing tube 3 may extend obliquely to pass through the first airflow concentrating cover 13 and the second airflow concentrating cover, such that one end of the airflow increasing tube 3 may be disposed in the negative pressure region, ensuring the airflow outputting efficiency of the airflow increasing tube 3.

In some implementations, a shape of the air outlet 121 may be (but not limited to): circular, elliptical, polygonal, or irregular. In the present implementation, the negative pressure region at the air outlet 121 may not be located inside or at a center of the air outlet 121, but may be located at an outside of the air outlet 121. Correspondingly, one end of the airflow increasing tube 3 in the present implementation may be arranged on the fan housing 1, and the other end or an extension line thereof may be disposed outside the air outlet 121.

Along a direction extending from the air inlet structure 111 to the air outlet 121, a distance between the first airflow concentrating cover 13 and the second airflow concentrating cover may gradually decrease. The gap between the first airflow concentrating cover 13 and the second airflow concentrating cover may form an air duct of the fan module inside the second housing 12.

When the distance between the first airflow concentrating cover 13 and the second airflow concentrating cover may gradually decrease, it may be indicated that, along the direction of the air outlet 121, the air duct may become narrower. As the air duct becomes narrower, the initial kinetic energy of the airflow flowing out of the air outlet 121 may be increased, the airflow may flow more quickly, and a better airflow blowing effect may be achieved. Furthermore, the increase in the airflow velocity at the air outlet 121 may cause a negative pressure value in the negative pressure region at the middle of the air outlet 121 to be lower, such that an airflow increasing efficiency of the airflow increasing tube 3 may be improved.

The fan module may further include: a negative pressure cover 15. The negative pressure cover 15 may be arranged inside the second airflow concentrating cover. A side edge of the negative pressure cover 15 may be connected to a side edge of the second airflow concentrating cover located at the air outlet 121. The end of the airflow increasing tube 3 that passes through the first airflow concentrating cover 13 and the second airflow concentrating cover may be connected to the negative pressure cover 15. By arranging the negative pressure cover 15, the negative pressure region may be more stable.

The first airflow concentrating cover 13 may include: a first cover body 131, an airflow concentrating plate 133, and a plurality of second airflow guide plates 132. The first cover body 131 may be connected to the second housing 12. The plurality of second airflow guide plates 132 may be arranged surrounding the airflow concentrating plate 133. One end of each of the plurality of second airflow guide plates 132 may be connected to an inner surface of the first cover body 131, and the other end of the second airflow guide plate 132 may be connected to the airflow concentrating plate 133. The end of the airflow increasing tube 3 connected to the negative pressure cover 15 may pass through the first airflow concentrating cover and the second airflow concentrating cover to be connected to the negative pressure cover 15. The end of the airflow increasing tube 3 connected to the negative pressure cover 15 may be exposed on the inner surface of the airflow increasing tube 3. In regard to configuration of the first airflow concentrating cover 13, by arranging the airflow concentrating plate 133 at the middle of the first cover body 131, an airflow passage area in the first airflow concentrating cover 13 for the airflow to pass through may be reduced, and the airflow may be acceleration for a first time. The first airflow concentrating cover 13 and the second airflow concentrating cover may continuously accelerate the airflow for a second time, such that the airflow passing through the fan module may have a greater initial kinetic energy.

The airflow concentrating plate 133 may cover the connection plate 163. The plurality of first airflow guide plates 162 and the plurality of second airflow guide plates 132 may be arranged in a one-to-one correspondence to each other. Each second airflow guide plate 132 may abut against a corresponding one of the plurality of first airflow guide plates 162. The one-to-one correspondence between the first airflow guide plates 162 and the second airflow guide plates 132 may avoid misalignment between the first airflow guide plates 162 and the second airflow guide plates 132, such that the airflow in the fan module may not be obstructed, the airflow outputting efficiency may be increased. The airflow concentrating plate 133 covering the connection plate 163 may extend a length of the connection plate 163 in an airflow path. When the airflow flows through the connection plate 163, a vortex may not be formed behind the connection plate 163, such that the airflow outputting efficiency of the fan assembly 4 may be improved.

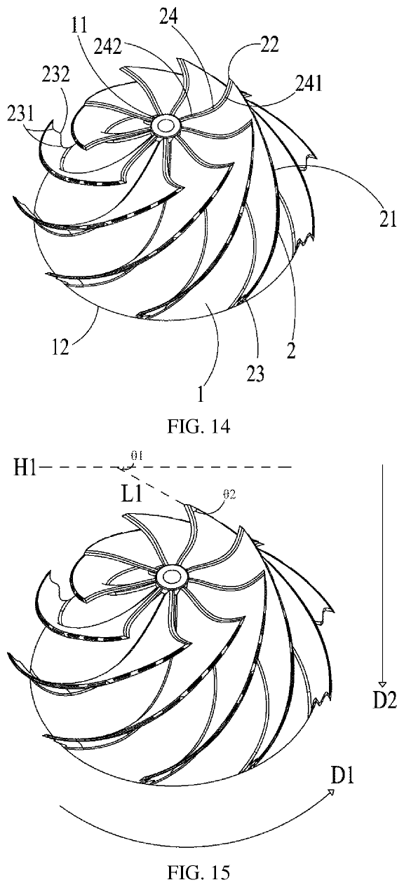

FIG. 13 is a perspective schematic view of the second airflow concentrating cover according to the present embodiment.

As shown in FIG. 13, an end of the second airflow concentrating cover facing away from the air outlet 121 may be sleeved on the airflow concentrating plate 133. The second airflow concentrating cover may be sleeved on the airflow concentrating plate 133, such that the connection between the second airflow concentrating cover and the first airflow concentrating cover 13 may be sealed connection, preventing the airflow inside the fan assembly 4 from flowing through a connected edge of the first airflow concentrating cover 13 and the second airflow concentrating cover, such that an effective airflow outputting efficiency of the air outlet 121 may not be affected. Furthermore, since the second airflow concentrating cover is sleeved, the airflow flowing therethrough may not form the vortex behind the airflow concentrating plate 133, and the airflow outputting efficiency of the fan module may be improved.

In some implementations, the connecting member 16 and the first airflow concentrating cover 13 may be integrally formed with each other.

The negative pressure cover 15 may be recessed inward toward the first housing 11 to form a curved surface 151. A surface of the airflow concentrating plate facing the negative pressure cover 15 may be recessed inward to form a curved groove 136. The curved groove 136 may be adaptive with the negative pressure cover 15 to enlarge a recessed space of the negative pressure cover 15. The negative pressure cover 15 recessed inward to form the curved surface may guide the airflow flowing out of the airflow increasing tube 3, causing the airflow to be concentrated and guided along the curved surface, such that the airflow outputting efficiency of the airflow increasing tube 3 may be increased. The surface of the airflow concentrating plate facing the negative pressure cover 15 may be recessed inward to form the curved groove 136. The curved groove 136 may be adaptive with the curved shape of the negative pressure cover 15, such that a larger recessed space of the negative pressure cover 15 may be formed, a curvature of the recess may be greater, and a stronger guiding effect on the airflow may be provided, and the airflow outputting efficiency of the fan module may be improved.

A plurality of support plates 134 may be arranged inside the first airflow concentrating cover 13. A plurality of connection grooves 141 may be defined in the outer surface of the second airflow concentrating cover 14. The plurality of support plates 134 may be in one-to-one correspondence with the plurality of connection grooves 141, and each support plate 134 may be inserted into a corresponding one of the plurality of connection grooves 141. The plurality of connection grooves 141 may extend along the outer surface of the second airflow concentrating cover 14.

The number of the plurality of support plates 134 may be two or more. Correspondingly, the number of the plurality of connection grooves 141 may be two or more.

The plurality of support plates 134 may be disposed on the inner surface of the end of the first cover body 131 facing the air outlet 121. The plurality of support plates 134 may be distributed in an annular pattern. An end of the support plate 134 contacting the second cover body may be curved. The connection groove 141 may extend along the outer surface of the second airflow concentrating cover 14. A part of the connection groove 141 that is not in contact with the support plate may have the guiding effect on the airflow. By arranging the plurality of support plates 134, a gap may be formed and stably maintained between the first airflow concentrating cover 13 and the second airflow concentrating cover, facilitating uniform airflow output from the fan module and improving the airflow outputting efficiency of the fan module.

In the present embodiment, the air inlet structure 111 may be a plurality of air inlet holes 111a defined in the second housing 12. The air inlet holes 111a may be defined in the side edge of the first housing 11. However, positions of the air inlet holes 111a may not be limited thereto. Depending on specific application scenarios, in some implementations, the air inlet holes 111a may be defined in the bottom surface of the first housing 11.

A structural form of the air inlet structure 111 may not be limited to the air inlet holes 111a. Depending on specific application scenarios, in some implementations, the air inlet structure 111 may be an air inlet port defined in the second housing 12.

The fan module may further include: a filter layer 2. The filter layer 2 may be arranged inside the second housing 12, and the filter layer 2 may be disposed at a position corresponding to the air inlet structure 111. The filter layer 2 may be made of filter materials such as filter cotton, activated carbon, fabric, and so on. The filter layer 2 may be configured as a folded structure. However, the structure of the folded filter layer 2 may not be limited thereto. Depending on specific application scenarios, in some implementations, the filter layer 2 may be a planar layer.

One end of the filter layer 2 may abut against the annular blocking rim 112, and the other end of the filter layer 2 may be connected to the bottom surface of the first housing 11.

In the present embodiment, the filter layer 2 may be configured to be annular. However, a shape of the filter layer 2 may not be limited thereto. Depending on specific application scenarios, in some implementations, the filter layer 2 may be configured to be (but not limited to) columnar, spherical, or ellipsoidal.

By arranging the air inlet structure 111 as the air inlet holes 111a, a large-sized foreign object or a finger may be prevented from extending into the fan module, causing unnecessary injury.

By arranging the filter layer 2 in the fan module, the air flowing through the fan module may be filtered, achieving air purification.

Combination of the filter layer 2 and the plurality of air inlet holes 111a may allow positions of the filter layer 2 for filtering the air to be distributed over a wider range, such that a filtering effect of the fan module may be improved.

The fan module may further include: an airflow guide cover 18. The airflow guide cover 18 may be disposed inside the first housing 11. One end of the airflow guide cover 18 may be connected to the connecting ring 161, and the other end of the airflow guide cover 18 may be connected to the filter layer 2. The airflow guide cover 18 may be configured in a trumpet shape and may cover the fan blades 41. Since the airflow guide cover 18 may prevent the airflow passing through the fan blades 41 from flowing reversely, arrangement of the airflow guide cover 18 may improve the airflow outputting efficiency of the fan module.

In some implementations, the airflow guide cover 18 and the first fan housing 1 may be integrally formed with each other. The inner wall of the first housing 11 may be protruding to form a structure identical to the airflow guide cover 18, and a same function as the airflow guide cover 18 may be achieved by performing an integral-forming manufacturing process.

In the present embodiment, the number of airflow guide tubes may be 6. The 6 airflow guide tubes may be distributed in a truncated cone shape on the second housing 12. It should be noted that the number of airflow guide tubes may not be limited thereto. Depending on specific application scenarios, in some implementations, the number of airflow guide tubes may be 1, 2, 3, 4, 5, 7, or more.

Each of the airflow guide tube may include a first end portion 31 and a second end portion 32. A surface of the second housing 12 may define at least one first through hole 124 having the same number as the number of airflow guide tubes. The first airflow concentrating cover 13 may define at least one second through hole 135 having the same number as the number of airflow guide tubes. The second airflow concentrating cover may define at least one third through hole 142 having the same number as the number of airflow guide tubes. The airflow concentrating cover may define at least one fourth through hole 152 having the same number as the number of airflow guide tubes. The first end portion 31 of the airflow guide tube may be exposed out of the first through hole 124. The second end portion 32 may pass through the corresponding first through hole 124, the corresponding second through hole 135, the corresponding third through hole 142, and the corresponding fourth through hole 152, and may be exposed on the surface of the negative pressure cover 15.

### Embodiment 3

As shown in FIGS. 14 and 15, FIG. 14 is a structural schematic view of a hub and blades according to the present embodiment; and FIG. 15 is a structural schematic view of the hub, blades, directions, and indicated angles according to the present embodiment.

As shown in FIGS. 14 and 15, a fan blade may include: a hub 1 and a plurality of blades 2. The hub 1 may be connected to a fan motor. The plurality of blades 2 may be arranged on and surrounding an outer surface of the hub 1. Each of the plurality of blades 2 may be curved and may extend along the surface of the hub 1 from a top end portion 11 of the hub 1 toward a side edge portion 12 of the hub 1, and each blade 2 may be twisted.

In the present embodiment, an overall shape of the hub 1 may be truncated conical. However, the overall shape of the hub 1 may not be limited thereto. Depending on specific application scenarios, in some implementations, the overall shape of the hub 1 may be configured to be conical, or in a bullet shape, or may be hemispherical, or may be cylindrical, and so on.

The number of blades 2 in the present embodiment may be 9. However, the number of blades 2 may not be limited thereto. Depending on specific application scenarios, in some implementations, the number of blades 2 may be (but not limited to): 2, 3, 4, 5, 6, 7, 8, 10, 11, or more.

In the above implementation, each of the plurality of blades 2 may be curved and extend along the surface of the hub 1 from the top end portion 11 of the hub 1 toward the side edge portion 12 of the hub 1, and each blade 2 may be twisted. During rotation, the blades 2 of the fan blade may push the airflow to rotate. Therefore, the airflow path inside the fan blade may be curved. Since each blade 2 is curved and extends from the top end portion 11 of the hub 1 toward the side edge portion 12, a shape of the blades 2 may match the curved path of the airflow, such that an airflow pushing efficiency and an airflow guiding efficiency of the fan blade may both be significantly improved. When the fan blade rotates, various positions of the blade 2 may have different effects on the airflow. For example, a blade tip 22 of the blade 2 may be substantially configured to cut the airflow; a position between the blade tip 22 and a blade tail 23 may be substantially configured to guide the airflow. The blade tail 23 may be substantially configured to output the airflow. Since various positions of the blade 2 have different functions, various positions of the blade 2 may have different shapes. For example, the blade tip 22 of the blade 2 may need to point toward a rotation direction of the fan blade to facilitate cutting the airflow. At the position between the blade tip 22 and the blade tail 23, a vertical distance from the blade 2 to the hub 1 may need to be larger to accommodate and intercept more airflow. The blade tail 23 of the blade 2 may need to extend in a direction opposite to the rotation direction D1 of the fan blade to reduce friction between the blade 2 and the outflowing airflow, such that aerodynamic noise and rotational resistance of the fan blade may be reduced. The twisted shape of the blade 2 may meet the requirements of the various positions, the airflow outputting efficiency of the fan blade may be improved, and the aerodynamic noise of the fan blade may be reduced.

The hub 1 may be configured to be conical or truncated conical. By configuring the hub 1 to be conical or truncated conical, a cross-sectional area at one end of the hub 1 may be less than a cross-sectional area at the other end of the hub 1. A surface of the hub 1 at the end having the smaller cross-sectional area may have more space for arranging the blades 2, such that the part of the blade 2 used for cutting the airflow may have a larger area, such that a better airflow cutting performance may be achieved.

In the present embodiment, the airflow direction during operation of the fan blade may be extending from the top end portion 11 of the hub 1 toward the edge portion 12 of the hub 1. Overall, the air intaking direction of the fan blade may be a direction indicated by D2.

In some implementations, each of the plurality of blades 2 may include: the blade tip 22. A facing direction of the blade tip 22 may be the same as the rotation direction D1 of the fan blade.

Since the facing direction of the blade tip 22 is the same as the rotation direction D1 of the fan blade, the blade tip 22 may form a “scooping” posture with respect to the contact airflow. At this posture, the blade tip 22 may cut the airflow more easily, and at the same time, the cut airflow may be guided to flow along the blade tip 22 to enter an interior of the fan blade. Therefore, the facing direction of the blade tip 22 may increase the amount of air intaken into the fan blade, and the air resistance and aerodynamic noise during rotation may be reduced.

In some implementations, each of the plurality of blades 2 may include: the blade tip 22. An angle θ1 between an extension line L1 of a pointing direction of the blade tip 22 and a horizontal direction H1 may be an acute angle.

In the present embodiment, the facing direction of the blade tip 22 may refer to a facing direction of the blade tip 22 with respect to the horizontal direction, and the pointing direction of the blade tip 22 may refer to a direction in which a tip end of the blade tip 22 points.

The angle θ1 between the extension line L1 of the pointing direction of the blade tip 22 and the horizontal direction H1 may be the acute angle. Therefore, the blade tip 22 may form the “scooping” posture with respect to the contact airflow. At this posture, the acute angle between the blade tip 22 and the cut airflow may allow the blade tip 22 to cut the airflow more conveniently and efficiently, the airflow resistance during rotation of the fan blade may be reduced, and a rotation efficiency of the fan blade may be improved.

In some implementations, an airflow-cutting inclined surface 24 may be arranged at a position of the blade tip 22. The airflow-cutting inclined surface 24 may extend in a direction opposite to the rotation direction D1 of the fan blade. An end of the airflow-cutting inclined surface 24 may be sharper. In this way, during rotation, the fan blade may cut the airflow better, the resistance during rotation may be reduced, and the rotation efficiency of the fan blade may be improved. Furthermore, since the airflow-cutting inclined surface 24 extends in the opposite direction to the rotation direction D1 of the fan blade, the blade 2 may better guide the airflow flowing over the surface of the fan blade, such that the airflow may leave the blade 2 of the fan blade at a larger angle, noise generated between the side edge and the airflow may be reduced.

The position of the blade tip 22 may not be limited to being arranged with the airflow-cutting inclined surface 24. Depending on specific application scenarios, in some implementations, the position of the blade tip 22 may be configured to be a rounded structure or a prismatic structure.

In some implementations, the airflow-cutting inclined surface 24 may include: a curved portion 241 and a linear portion 242. One end of the linear portion 242 may be connected to the surface of the hub 1, the other end of the linear portion 242 may be connected to the curved portion 241, and the other end of the curved portion 241 may be connected to a blade edge 21.

In some implementations, an angle θ2 between the blade tip 22 and the blade edge 21 may be an acute angle. Configuration of the blade tip 22 and the blade edge 21 may enable an outermost end of the blade tip 22 to protrude to form a sharp portion. Due to the acute-angle configuration, when the blade tip 22 cuts the airflow, a contact area between the blade tip 22 and the airflow may gradually increase as the fan blade rotates, such that the fan blade may cut the airflow easily, rotational air resistance may be reduced, and the rotation efficiency of the fan blade may be improved.

The angle between the blade tip 22 and the blade edge 21 may not be limited to the acute angle. Depending on specific application scenarios, in some implementations, the angle between the blade tip 22 and the blade edge 21 may be a right angle or an obtuse angle.

In some implementations, each of the plurality of blades 2 may include: the blade tail 23. The blade tail 23 may be curved in a direction opposite to the rotation direction D1 of the fan blade.

According to the physical principle of action and reaction, when the fan blade rotates in the rotation direction D1, the airflow flowing through the fan blade may tend to move in a direction opposite to the rotation direction of the fan blade. When the airflow flows along the shape of the blade 2, the blade tail 23 extends in a curved manner in the direction opposite to the rotation direction D1 of the fan blade. The curved configuration may match a flowing tendency of the airflow inside the fan blade, allowing the blade 2 to constrain the airflow more smoothly, such that the airflow outputting efficiency of the fan may be improved. Furthermore, since the curved direction of the blade tail 23 may be consistent with the flowing tendency of the airflow, rubbing between the blade tail 23 and the outflowing airflow may be reduced, such that the aerodynamic noise generated by the airflow at the blade tail 23 may be reduced.

In some implementations, the airflow-cutting inclined surface 24 may include: the curved portion 241 and the linear portion 242. One end of the linear portion 242 may be connected to the surface of the hub 1, the other end of the linear portion 242 may be connected to the curved portion 241, and the other end of the curved portion 241 may be connected to the blade edge 21. An outer part of the airflow-cutting inclined surface 24 may be configured as the curved portion 241. As the blade 2 rotates with the hub 1, the contact area between the curved portion 241 and the airflow may gradually increase, and the curved portion 241 on the outer side may have a greater linear velocity. Therefore, the curved portion 241 may cut the airflow better, increasing the airflow cutting capability of the blade tip 22. Furthermore, various positions of the curved portion 241 may contact the airflow gradually in a stepwise manner, resistance to the airflow may be reduced, and the aerodynamic noise generated during rotation of the fan blade may be reduced. The linear portion 242, which may be connected to the curved portion 241, may be located at an inner side of the blade tip 22. Compared to the curved portion 241, the linear portion 242 may rotate at a lower linear velocity, and therefore, the linear portion 242 may encounter reduced air resistance. The linear configuration of the linear portion 242 may enable the entire linear portion 242 to contact the airflow simultaneously, such that an airflow-cutting area of the airflow-cutting inclined surface 24 may be increased. In this way, the airflow-cutting inclined surface 24 may have the increases airflow-cutting efficiency through the curved portion 241 and have the increased airflow-cutting amount through the linear portion 242.

In some implementations, a length of the blade tip 22 may be greater than a length of the blade tail 23. The blade tip 22 may be configured to cut the airflow during rotation of the fan blade. By increasing the width of the blade tip 22, the airflow-cutting area of the blade tip 22 may be increased, the air intaking efficiency of the blade tip 22 may be increased. The blade tail 23 may be configured to output the airflow. Since the width of the blade tail 23 may be smaller, an ability of the blade tail 23 constraining the outflowing airflow may be reduced, friction between the outflowing airflow and the blade tail 23 may be smaller, the airflow outputting efficiency of the blade tail 23 may be increased, and the aerodynamic noise of the blade tail 23 may be reduced.

A length relationship between the blade tip 22 and the blade tail 23 may not be limited to the above. Depending on specific application scenarios, in some implementations, the length of the blade tip 22 may be equal to the length of the blade tail 23, or the length of the blade tip 22 may be less than the length of the blade tail 23.

In some implementations, at least one curved notch 231 may be formed at the blade tail 23. When the fan blade rotates, the internal airflow may rotate synchronously with the fan blade, generating a rotating airflow. For two adjacent blades 2, after the airflow exits from the blade tail 23 of one of the two adjacent blades located at a front position, the rotating airflow may move inclinedly due to inertia. The inclined airflow may collide with the airflow exiting from the blade tail 23 of the other one of the two adjacent blades located at a rear position. Merging of the two fixed-direction airflows may generate a vortex, affecting the airflow outputting efficiency of the fan blade. By forming the curved notch 231 at the blade tail 23, the airflow exiting from the blade tail 23 of each blade 2 may be split into a plurality of sub-airflows. Each of the plurality of sub-airflows may have a reduced energy, preventing an energy and a path of the airflow exiting from the blade tail 23 from being excessively concentrated and from colliding with the airflow exiting from the blade tail 23 of the rear blade 2, such that the vortex may be prevented. The airflow outputting efficiency of the fan blade may be improved, and the aerodynamic noise of the fan blade may be reduced.

In the present embodiment, the number of the at least one curved notch 231 at the blade tail 23 may be 2. However, the number of the at least one curved notch 231 may not be limited thereto. Depending on specific application scenarios, in some implementations, the number of the at least one curved notch 231 may be (but not limited to): 2, 3, 4, 5, or more.

A notch surface of the curved notch 231 may be smooth and rounded, causing reduced resistance to the airflow passing therethrough. Therefore, by forming the curved notch 231, the airflow outputting efficiency of the blade tail 23 may be increased. Furthermore, along one linear dimension, two sides of the curved notch 231 may be symmetrical to each other. In this way, inconsistency in airflow velocities after pressure relief on a left side and a right side of the blade 2 may be avoided, such that blade vibration may be avoided, rotational stability of the fan blade may be improved, and the aerodynamic noise of the fan blade may be reduced.

A shape of the notch at the blade tail 23 may not limited to the above. Depending on specific application scenarios, in some implementations, the notch at the blade tail 23 may be (but not limited to): wedge-shaped, quadrilateral, other polygonal, or heart-shaped.

In some implementations, a connection position between the curved portion 241 and the blade edge 21 may be configured to be the acute angle. The sharp portion, which is formed by the connection of the curved portion 241 and the blade edge 21 at the acute angle, may be more protruding, providing a better airflow-cutting effect. Furthermore, the curved portion 241 may guide the airflow, causing the airflow to move toward the hub 1 along the curved portion 241, improving the ability of the fan blade to converge the intaken airflow to enable the airflow to be more concentrated.

In some implementations, when two or more curved notches 231 are arranged at the blade tail 23, a curved protrusion 232 may be formed between every two adjacent curved notches 231. The curved protrusion 232 may be curved in a direction opposite to the curved notch 231. When two or more curved notches 231 are arranged at the blade tail 23, the curved protrusion 232 may be formed between every two adjacent curved notches 231. By arranging the curved protrusion 232, the airflow exiting from the blade tail 23 may be further split. In this way, the airflow outputting efficiency of the fan blade may be further improved, and the aerodynamic noise of the fan blade may be reduced.

In some implementations, when two or more curved notches 231 are arranged at the blade tail 23, an area of the curved notch 231 may gradually decrease in a direction extending from the hub 1 toward the blade edge 21. During rotation of the fan blade, the airflow inside the fan blade may be gradually weakened in the direction from the hub 1 toward the blade edge 21. Therefore, the area of the curved notch 231 may gradually decrease in the direction from the hub 1 toward the blade edge 21, a larger curved notch 231 may release and relieve pressure for a stronger airflow, and a smaller curved notch 231 may release and relieve pressure for a weaker airflow. In this way, equivalent pressure relief and equivalent airflow release may be achieved at different positions of the blade tail 23 corresponding to various strength levels of the airflows at various positions, such that the blade tail 23 may output the airflow in a balanced manner. Due to balanced airflow outputting, unbalanced airflow release at various positions of the blade tail 23 may be avoided, such that localized vibration may be avoided, and the aerodynamic noise of the fan blade may be reduced.

It should be noted that implementations in the present embodiment may be implemented independently or in combination with each other. When combined, the combination manner shall not be limited to the combinations listed in the present embodiment.

### Embodiment 4

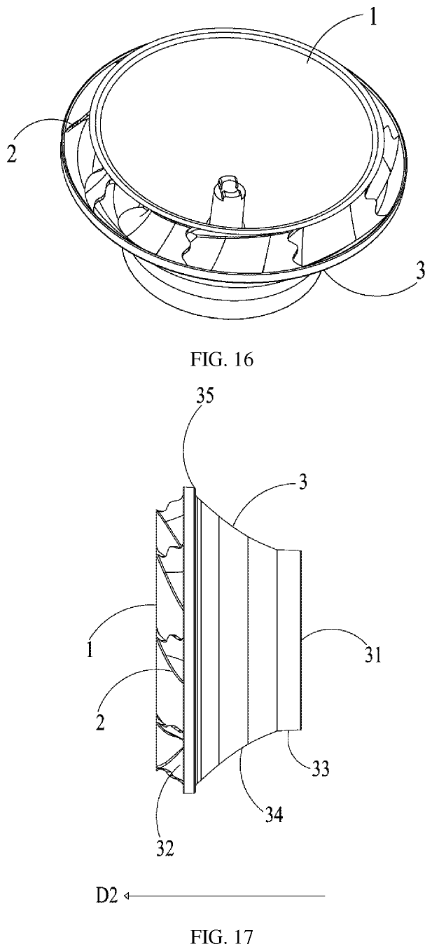

As shown in FIGS. 16 and 17, FIG. 16 is a perspective structural schematic view of the fan blade according to the present embodiment; and FIG. 17 is a structural schematic view of the fan blade, being viewed from a first viewing angle, according to the present embodiment.

As shown in FIGS. 16 and 17, the fan blade may include: a hub 1, a plurality of blades 2, and a fan cover 3.

The hub 1 may be connected to a fan motor. The plurality of blades 2 may be arranged on and surrounding an outer surface of the hub 1. The fan cover 3 may cover the plurality of blades 2, and a blade edge 21 of each of the plurality of blades 2 may be connected to the fan cover 3.

In the present embodiment, an overall shape of the hub 1 may be configured to be truncated conical. However, the overall shape of the hub 1 may not be limited thereto. Depending on specific application scenarios, in some implementations, the overall shape of the hub 1 may be configured as: a cone, a bullet shape, a hemisphere, a cylinder, and so on.

The number of the plurality of blades 2 in the present embodiment may be 9. However, the number of the plurality of blades 2 may not be limited thereto. Depending on specific application scenarios, in some implementations, the number of the plurality of blades 2 may be (but not limited to): 2, 3, 4, 5, 6, 7, 8, 10, 11, or more.

In the present embodiment, an inner surface of the fan cover 3 may be connected to the blade edge 21 of each blade 2. A connection manner between the blade edge 21 and the inner surface of the fan cover 3 may be: thermal fusion bonding. A possible thermal fusion bonding process may be ultrasonic thermal fusion bonding. However, the connection manner between the fan cover 3 and the blade edge 21 may not be limited thereto. Depending on specific application scenarios, in some implementations, the connection manner between the blade edge 21 and the inner surface of the fan cover 3 may be (but not limited to): adhesive bonding, welding, snap-fitting, slot connection, and so on.

In the above implementation, the fan cover 3 may be arranged, covering the fan blades 2, and the blade edge 21 of the blade 2 may be connected to the fan cover 3. By arranging the fan cover 3, an air duct, which has a closed side, may be created between the hub 1 and the fan cover 3. In the air duct, when the blades push the airflow to rotate a side wall of the fan cover 3 may block and counteract a centrifugal force on the airflow, the airflow flowing through the blades may be prevented from escaping out due to the centrifugal force, such that the airflow outputting efficiency and the amount of the output airflow of the fan blade may be improved. Furthermore, since any escaping path of the airflow may be restricted by the fan cover 3, the escaping rotating airflow cannot form an airflow vortex that would affect the rotation of the blades, such that the aerodynamic noise caused by airflow vortex may be avoided, and the aerodynamic noise of the fan blade may be greatly reduced. Furthermore, due to arranging the fan cover 3 for covering, the blade edges 21 of the blades may not rub or collide with the airflow inside the blades, resistance against rotation of the blades may be reduced, the rotation efficiency of the blades may be higher. Furthermore, the aerodynamic noise caused by friction between the blade edges 21 and the airflow may be reduced, further reducing the aerodynamic noise of the fan blade.

In some implementations, each of the plurality of blades 2 may extend to be curved along the surface of the hub 1 from the top end portion 11 of the hub 1 toward the side edge portion 12. Each blade 2 may be twisted. During rotation, the blades 2 of the fan blade may push the airflow to rotate, the airflow path inside the fan blade may be curved. Since each blade 2 extends to be curved from the top end portion 11 of the hub 1 toward the side edge portion 12, a shape of the blade 2 may match the curved path of the airflow, such that an airflow pushing efficiency and the airflow guiding efficiency of the fan blade may be significantly improved. When the fan blade rotates, various positions of the blade 2 may have different effects on the airflow. For example, the blade tip 22 of the blade 2 may be substantially configured to cut the airflow; a position between the blade tip 22 and the blade tail 23 may be substantially configured to guide the airflow. The blade tail 23 may be substantially configured to output the airflow. Since various positions of the blade 2 have different functions, various positions of the blade 2 may have different shapes. For example, the blade tip 22 of the blade 2 may need to point toward the rotation direction of the fan blade to facilitate cutting the airflow. At the position between the blade tip 22 and the blade tail 23, a vertical distance of the blade 2 with respect to the hub 1 may need to be larger to accommodate and intercept more airflow. The blade tail 23 of the blade 2 may need to extend in a direction opposite to the rotation direction D1 of the fan blade to reduce friction between the blade 2 and the outflowing airflow, such that aerodynamic noise and rotational resistance of the fan blade may be reduced. The twisted shape of the blade 2 may meet the requirements of the various positions, the airflow outputting efficiency of the fan blade may be improved, and the aerodynamic noise of the fan blade may be reduced.

The hub 1 may be configured to be conical or truncated conical. The fan cover 3 may define a first opening 31 and a second opening 32 along the air intaking direction D2 of the fan blade, and an opening area of the second opening 32 may be greater than an opening area of the first opening 31. By configuring the hub 1 to be conical or truncated conical, the cross-sectional area at one end of the hub 1 may be less than the cross-sectional area at the other end of the hub 1. The surface of the hub 1 at the end having the smaller cross-sectional area may have more space for arranging the blades 2, such that the part of the blade 2 for cutting the airflow may have a larger area, achieving better airflow cutting performance. The first opening 31 and the second opening 32 defined in the fan cover 3 may correspond to the air inlet and air outlet of the fan blade, respectively. The opening area of the first opening 31 is smaller than the opening area of the second opening 32, such that a speed at which the airflow enters the fan blade may be limited to be slower, the airflow may be controlled more easily, and the airflow vortex may be less likely to be generated. In this way, a rectifying effect on the airflow entering the fan blade may be achieved, and the airflow may circulate more flow inside the fan blade. The opening area of the second opening 32 may be greater than the opening area of the first opening 31, such that the airflow may exit the fan blade more quickly, facilitating pressure relief and reducing aerodynamic noise at the air outlet of the fan blade.

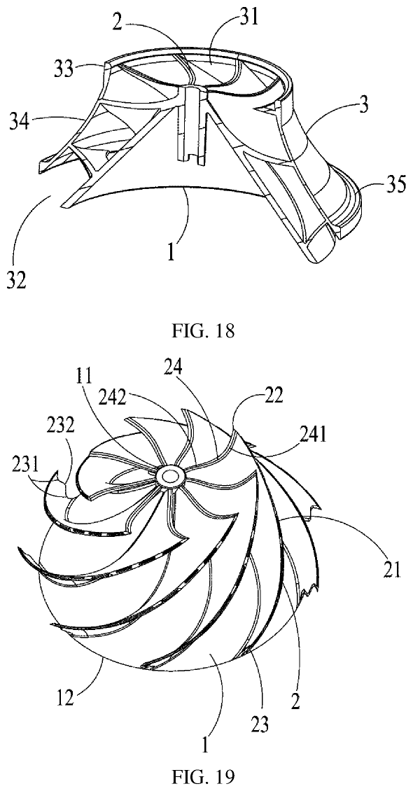

FIG. 18 is a cross-sectional schematic view of the fan blade according to the present embodiment.

As shown in FIG. 18, in some implementations, the fan cover 3 may include: an air inlet ring 33 and an airflow guide cover 34. The air inlet ring 33 may be connected to the airflow guide cover 34. The first opening 31 may be defined in the air inlet ring 33, and the second opening 32 may be defined in the airflow guide cover 34.

The air inlet ring 33 and the airflow guide cover 34 may be integrally formed with each other. Therefore, connection between the air inlet ring 33 and the airflow guide cover 34 in the present embodiment may include any connection manner formed by the integral forming. However, the connection manner between the air inlet ring 33 and the airflow guide cover 34 may not be limited thereto. Depending on specific application scenarios, in some implementations, the connection manner between the air inlet ring 33 and the airflow guide cover 34 may include (but not limited to): adhesive bonding, thermal fusion bonding, welding, insertion, snap-fitting, and so on.

In some implementations, a thickness of the air inlet ring 33 may gradually increase in a direction opposite to the air intaking direction D2 of the fan blade. During rotation, the fan blade may drive the airflow flow therethrough to rotate to be output. However, the rotation of the fan blade may further cause a small portion of the intaken airflow to be scattered to create a turbulent airflow. When the turbulent airflow flows in a direction opposite to the air intaking direction D2 of the fan blade, a reverse airflow may be generated, which may interfere with normal air intaking of the fan blade, reducing an air intaking efficiency of the fan blade. As the thickness of the air inlet ring 33 gradually increases in the direction opposite to the air intake direction D2 of the fan blade, the reverse airflow may be blocked, and the air intaking efficiency of the fan blade may be improved.

In some implementations, in the direction opposite to the air intaking direction D2 of the fan blade, the thickness of the air inlet ring 33 may gradually increase to reach a maximum thickness and may then gradually decrease. In this way, the reverse airflow of the fan blade may be blocked. Furthermore, in the direction opposite to the air intaking direction D2 of the fan blade, since the thickness of the air inlet ring 33 gradually increases to reach the maximum thickness and then gradually decreases, an opening area of an outermost opening of the air inlet ring 33 may be increased, the amount of the air intaken by the fan blade may be increased, and the air intaking efficiency of the fan blade may be increased.

In some implementations, a position of an outer surface of the airflow guide cover 34 near the second opening 32 may be protruding to form an annular blocking rim 35. When the fan blade rotates, a negative pressure region may be formed at the second opening 32 of the fan cover 3. After the negative pressure region is formed, surrounding air around the fan cover 3 may flow along the surface of the fan cover 3 from the first opening 31 toward the second opening 32, forming an external airflow. The external airflow may meet the airflow exiting from the second opening 32 of the fan blade, and meeting of the two airflows with different velocities may create an airflow vortex, such that the airflow outputting efficiency of the fan blade may be reduced. By arranging the annular blocking rim 35, the external airflow may be blocked from flowing toward the second opening 32, a kinetic energy of the external airflow may be reduced, and a possibility of vortex formation due to the airflow meeting may be reduced, such that the airflow outputting efficiency of the fan blade may be improved.

Furthermore, when the fan blade of the present embodiment is assembled into a fan, the airflow exiting from the fan blade may further flow for a certain distance inside the fan housing before exiting an air outlet of the fan. During the above process, due to obstruction by an inner wall of the fan housing or a size of the air outlet of the fan, the airflow flowing along an outputting direction may flow reversely. The reversely-flowing airflow may flow along the surface of the fan cover 3 from the second opening 32 toward the first opening 31. In this case, two airflows, flowing in opposite directions on the surface of the fan cover 3, may meet each other, creating an airflow vortex, such that the air intaking efficiently and the airflow outputting efficiency of the fan blade may be affected. The annular blocking rim 35 may further block the reversely-flowing airflow, reducing an energy of merging between the reversely-flowing airflow and the external airflow and reducing a possibility and an energy of vortex formation, such that the air intaking efficiently and the airflow outputting efficiency of the fan blade may be improved. Therefore, the annular blocking rim 35 may block merging of two airflows flowing in opposite directions.

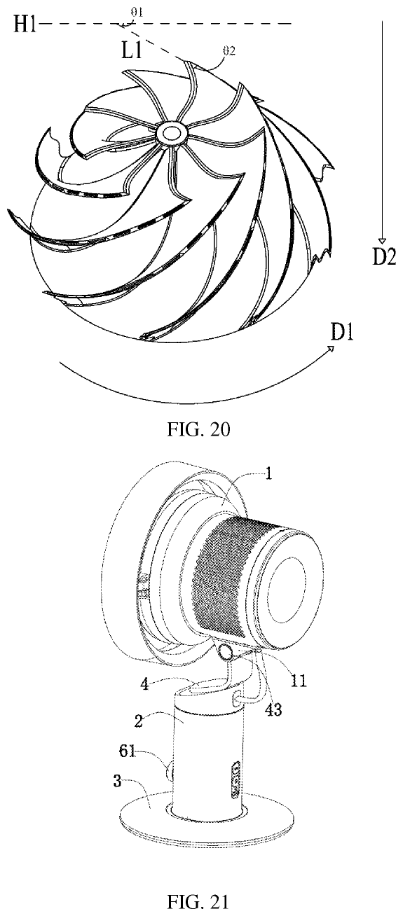

As shown in FIGS. 19 and 20, FIG. 19 is a structural schematic view of the hub and the blades according to the present embodiment; and FIG. 20 is a structural schematic view of the hub, the blades, the directions, and the indicated angles according to the present embodiment.

As shown in FIG. 19, in some implementations, each of the plurality of blades 2 may include: the blade tip 22. The facing direction of the blade tip 22 may be the same as the rotation direction D1 of the fan blade.

Since the facing direction of the blade tip 22 is the same as the rotation direction D1 of the fan blade, the blade tip 22 may form a “scooping” posture with respect to the contact airflow. At this posture, the blade tip 22 may cut the airflow more easily, and at the same time, the cut airflow may be guided to flow along the blade tip 22 to enter an interior of the fan blade. Therefore, the facing direction of the blade tip 22 may increase the amount of air intaken into the fan blade, and the air resistance and aerodynamic noise during rotation may be reduced.

In some implementations, each of the plurality of blades 2 may include: the blade tip 22. An angle θ1 between an extension line L1 of a pointing direction of the blade tip 22 and a horizontal direction H1 may be an acute angle.

In the present embodiment, the facing direction of the blade tip 22 may refer to a facing direction of the blade tip 22 with respect to the horizontal direction, and the pointing direction of the blade tip 22 may refer to a direction in which a tip end of the blade tip 22 points.

The angle θ1 between the extension line L1 of the pointing direction of the blade tip 22 and the horizontal direction H1 may be the acute angle. Therefore, the blade tip 22 may form the “scooping” posture with respect to the contact airflow. At this posture, the acute angle θ1 between the blade tip 22 and the cut airflow may allow the blade tip 22 to cut the airflow more conveniently and efficiently, the airflow resistance during rotation of the fan blade may be reduced, and a rotation efficiency of the fan blade may be improved.

In some implementations, an airflow-cutting inclined surface 24 may be arranged at a position of the blade tip 22. The airflow-cutting inclined surface 24 may extend in a direction opposite to the rotation direction D1 of the fan blade. An end of the airflow-cutting inclined surface 24 may be sharper. In this way, during rotation, the fan blade may cut the airflow better, the resistance during rotation may be reduced, and the rotation efficiency of the fan blade may be improved. Furthermore, since the airflow-cutting inclined surface 24 extends in the opposite direction to the rotation direction D1 of the fan blade, the blade 2 may better guide the airflow flowing over the surface of the fan blade, such that the airflow may leave the blade 2 of the fan blade at a larger angle, noise generated between the side edge and the airflow may be reduced.

The position of the blade tip 22 may not be limited to being arranged with the airflow-cutting inclined surface 24. Depending on specific application scenarios, in some implementations, the position of the blade tip 22 may be configured to be a rounded structure or a prismatic structure.

In some implementations, the airflow-cutting inclined surface 24 may include: a curved portion 241 and a linear portion 242. One end of the linear portion 242 may be connected to the surface of the hub 1, the other end of the linear portion 242 may be connected to the curved portion 241, and the other end of the curved portion 241 may be connected to a blade edge 21.

In some implementations, an angle θ2 between the blade tip 22 and the blade edge 21 may be an acute angle. Configuration of the blade tip 22 and the blade edge 21 may enable an outermost end of the blade tip 22 to protrude to form a sharp portion. Due to the acute-angle configuration, when the blade tip 22 cuts the airflow, a contact area between the blade tip 22 and the airflow may gradually increase as the fan blade rotates, such that the fan blade may cut the airflow easily, rotational air resistance may be reduced, and the rotation efficiency of the fan blade may be improved.

The angle between the blade tip 22 and the blade edge 21 may not be limited to the acute angle. Depending on specific application scenarios, in some implementations, the angle between the blade tip 22 and the blade edge 21 may be a right angle or an obtuse angle.

In some implementations, each of the plurality of blades 2 may include: the blade tail 23. The blade tail 23 may be curved in a direction opposite to the rotation direction D1 of the fan blade.

According to the physical principle of action and reaction, when the fan blade rotates in the rotation direction D1, the airflow flowing through the fan blade may tend to move in a direction opposite to the rotation direction of the fan blade. When the airflow flows along the shape of the blade 2, the blade tail 23 extends in a curved manner in the direction opposite to the rotation direction D1 of the fan blade. The curved configuration may match a flowing tendency of the airflow inside the fan blade, allowing the blade 2 to constrain the airflow more smoothly, such that the airflow outputting efficiency of the fan may be improved. Furthermore, since the curved direction of the blade tail 23 may be consistent with the flowing tendency of the airflow, rubbing between the blade tail 23 and the outflowing airflow may be reduced, such that the aerodynamic noise generated by the airflow at the blade tail 23 may be reduced.

In some implementations, the airflow-cutting inclined surface 24 may include: the curved portion 241 and the linear portion 242. One end of the linear portion 242 may be connected to the surface of the hub 1, the other end of the linear portion 242 may be connected to the curved portion 241, and the other end of the curved portion 241 may be connected to the blade edge 21. An outer part of the airflow-cutting inclined surface 24 may be configured as the curved portion 241. As the blade 2 rotates with the hub 1, the contact area between the curved portion 241 and the airflow may gradually increase, and the curved portion 241 on the outer side may have a greater linear velocity. Therefore, the curved portion 241 may cut the airflow better, increasing the airflow cutting capability of the blade tip 22. Furthermore, various positions of the curved portion 241 may contact the airflow gradually in a stepwise manner, resistance to the airflow may be reduced, and the aerodynamic noise generated during rotation of the fan blade may be reduced. The linear portion 242, which may be connected to the curved portion 241, may be located at an inner side of the blade tip 22. Compared to the curved portion 241, the linear portion 242 may rotate at a lower linear velocity, and therefore, the linear portion 242 may encounter reduced air resistance. The linear configuration of the linear portion 242 may enable the entire linear portion 242 to contact the airflow simultaneously, such that an airflow-cutting area of the airflow-cutting inclined surface 24 may be increased. In this way, the airflow-cutting inclined surface 24 may have the increases airflow-cutting efficiency through the curved portion 241 and have the increased airflow-cutting amount through the linear portion 242.

In some implementations, a length of the blade tip 22 may be greater than a length of the blade tail 23. The blade tip 22 may be configured to cut the airflow during rotation of the fan blade. By increasing the width of the blade tip 22, the airflow-cutting area of the blade tip 22 may be increased, the air intaking efficiency of the blade tip 22 may be increased. The blade tail 23 may be configured to output the airflow. Since the width of the blade tail 23 may be smaller, an ability of the blade tail 23 constraining the outflowing airflow may be reduced, friction between the outflowing airflow and the blade tail 23 may be smaller, the airflow outputting efficiency of the blade tail 23 may be increased, and the aerodynamic noise of the blade tail 23 may be reduced. Furthermore, since overall, an area on an air intaking side of the fan blade is smaller than an area on an airflow outputting side of the fan blade, i.e., the opening area of the first opening 31 is smaller than the opening area of the second opening 32, an airflow outputting area may be greater than an air intaking area. Since the length of the blade tip 22 is greater than the length of the blade tail 23, the amount of the intaken air may be increased, air pressures on both sides may be balanced to each other. An airflow loss, due to a large pressure difference between the two sides of the fan blade, may be avoided. An operating efficiency of the fan blade may be improved.

A length relationship between the blade tip 22 and the blade tail 23 may not be limited to the above. Depending on specific application scenarios, in some implementations, the length of the blade tip 22 may be equal to the length of the blade tail 23, or the length of the blade tip 22 may be less than the length of the blade tail 23.

In some implementations, at least one curved notch 231 may be formed at the blade tail 23. When the fan blade rotates, the internal airflow may rotate synchronously with the fan blade, generating a rotating airflow. For two adjacent blades 2, after the airflow exits from the blade tail 23 of one of the two adjacent blades located at a front position, the rotating airflow may move inclinedly due to inertia. The inclined airflow may collide with the airflow exiting from the blade tail 23 of the other one of the two adjacent blades located at a rear position. Merging of the two fixed-direction airflows may generate a vortex, affecting the airflow outputting efficiency of the fan blade. By forming the curved notch 231 at the blade tail 23, the airflow exiting from the blade tail 23 of each blade 2 may be split into a plurality of sub-airflows. Each of the plurality of sub-airflows may have a reduced energy, preventing an energy and a path of the airflow exiting from the blade tail 23 from being excessively concentrated and from colliding with the airflow exiting from the blade tail 23 of the rear blade 2, such that the vortex may be prevented. The airflow outputting efficiency of the fan blade may be improved, and the aerodynamic noise of the fan blade may be reduced.

In the present embodiment, the number of the at least one curved notch 231 at the blade tail 23 may be 2. However, the number of the at least one curved notch 231 may not be limited thereto. Depending on specific application scenarios, in some implementations, the number of the at least one curved notch 231 may be (but not limited to): 2, 3, 4, 5, or more.

A notch surface of the curved notch 231 may be smooth and rounded, causing reduced resistance to the airflow passing therethrough. Therefore, by forming the curved notch 231, the airflow outputting efficiency of the blade tail 23 may be increased. Furthermore, along one linear dimension, two sides of the curved notch 231 may be symmetrical to each other. In this way, inconsistency in airflow velocities after pressure relief on a left side and a right side of the blade 2 may be avoided, such that blade vibration may be avoided, rotational stability of the fan blade may be improved, and the aerodynamic noise of the fan blade may be reduced.

A shape of the notch at the blade tail 23 may not limited to the above. Depending on specific application scenarios, in some implementations, the notch at the blade tail 23 may be (but not limited to): wedge-shaped, quadrilateral, other polygonal, or heart-shaped.

In some implementations, a connection position between the curved portion 241 and the blade edge 21 may be configured to be the acute angle. The sharp portion, which is formed by the connection of the curved portion 241 and the blade edge 21 at the acute angle, may be more protruding, providing a better airflow-cutting effect. Furthermore, the curved portion 241 may guide the airflow, causing the airflow to move toward the hub 1 along the curved portion 241, improving the ability of the fan blade to converge the intaken airflow to enable the airflow to be more concentrated.

In some implementations, when two or more curved notches 231 are arranged at the blade tail 23, a curved protrusion 232 may be formed between every two adjacent curved notches 231. The curved protrusion 232 may be curved in a direction opposite to the curved notch 231. When two or more curved notches 231 are arranged at the blade tail 23, the curved protrusion 232 may be formed between every two adjacent curved notches 231. By arranging the curved protrusion 232, the airflow exiting from the blade tail 23 may be further split. In this way, the airflow outputting efficiency of the fan blade may be further improved, and the aerodynamic noise of the fan blade may be reduced.

In some implementations, when two or more curved notches 231 are arranged at the blade tail 23, an area of the curved notch 231 may gradually decrease in a direction extending from the hub 1 toward the blade edge 21. During rotation of the fan blade, the airflow inside the fan blade may be gradually weakened in the direction from the hub 1 toward the blade edge 21. Therefore, the area of the curved notch 231 may gradually decrease in the direction from the hub 1 toward the blade edge 21, a larger curved notch 231 may release and relieve pressure for a stronger airflow, and a smaller curved notch 231 may release and relieve pressure for a weaker airflow. In this way, equivalent pressure relief and equivalent airflow release may be achieved at different positions of the blade tail 23 corresponding to various strength levels of the airflows at various positions, such that the blade tail 23 may output the airflow in a balanced manner. Due to balanced airflow outputting, unbalanced airflow release at various positions of the blade tail 23 may be avoided, such that localized vibration may be avoided, and the aerodynamic noise of the fan blade may be reduced.

It should be noted that any implementation in this embodiment can be implemented independently or in combination with each other. When combined, the combination manner shall not be limited to the combinations listed in the present embodiment.

### Embodiment 5

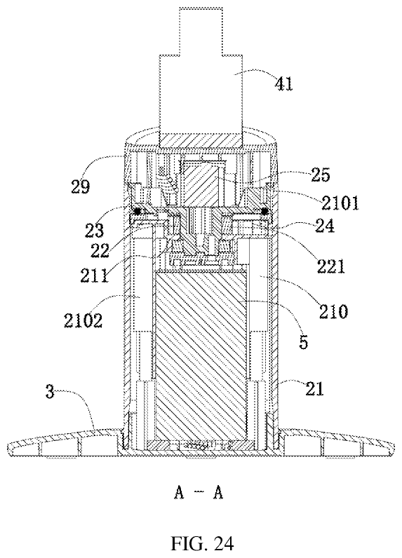

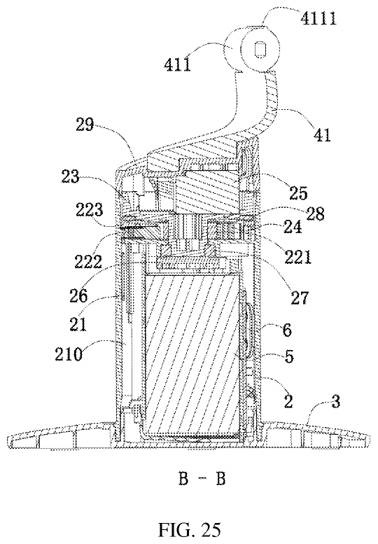

As shown in FIGS. 21-25, the present embodiment provides a fan, including: a fan component 1, a swing component 2, a base 3, a connecting assembly 4, a rechargeable battery 5, and a control circuit board 6. Specifically, the fan component 1 may be connected to the swing component 2 through the connecting assembly 4, a bottom of the swing component 2 may be connected to the base 3, and the rechargeable battery 5 and the control circuit board 6 may both be arranged inside the swing component 2.

It should be noted that the rechargeable battery 5 may be connected to the fan component 1 and the swing component 2 to supply power the fan component 1 and the swing component 2.

The rechargeable battery 5 may further be connected to the control circuit board 6, such that the control circuit board 6 may control the fan component 1 to start or stop operating, and may control the swing component 2 to swing to output the airflow or to output the airflow at a fixed position. In the present embodiment, the fan component 1 may be available in the related art and will not be described in detail here.

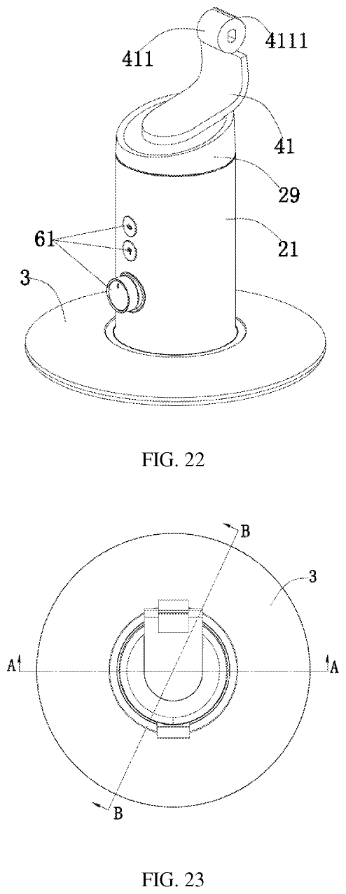

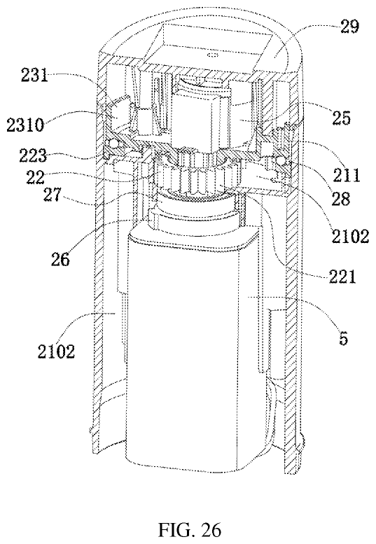

As shown in FIGS. 23-27, in an embodiment, the swing component 2 may include: a support column 21, a fixing assembly 22, a rotation bracket 23, a transmission member 24, and a rotation source 25.

The support column 21 may define an installation cavity 210, and a partition member 211 may be received in the installation cavity 210. The installation cavity 210 may be divided by the partition member 211 into an assembly compartment 2101 and a battery compartment 2102. The rechargeable battery 5 and the control circuit board 6 may be installed in the battery compartment 2102. The fixing assembly 22 may be received in the assembly compartment 2101 and may be connected to the partition member 211. The rotation bracket 23 may be movably assembled in the assembly compartment 2101. The rotation bracket 23 may be disposed at a side of the fixing assembly 22 away from the partition member 21, and a part of the rotation bracket 23 may pass through the fixing assembly 22. The transmission member 24 may be carried on the partition member 211 and may be meshed with the fixing assembly 22. The rotation source 25 may be fixedly mounted on the rotation bracket 23, and a power output shaft of the rotation source 25 may be connected to the transmission member 24. The rotation source 25 may drive the transmission member 24 to rotate, causing the transmission member 24 to move around the fixing assembly 22, driving the power source 25 and the rotation bracket 23 to rotate relative to the support column 21.

It should be noted that the control circuit board 6 may be arranged with a plurality of control buttons 61 to control an airflow volume, starting/stopping operation of the fan component 1, and the starting/stopping operation of the swing component 2. A plurality of mounting openings may be correspondingly defined in an inner side wall of the battery compartment 2102, and the plurality of control buttons 61 may be correspondingly installed in the plurality of mounting openings.

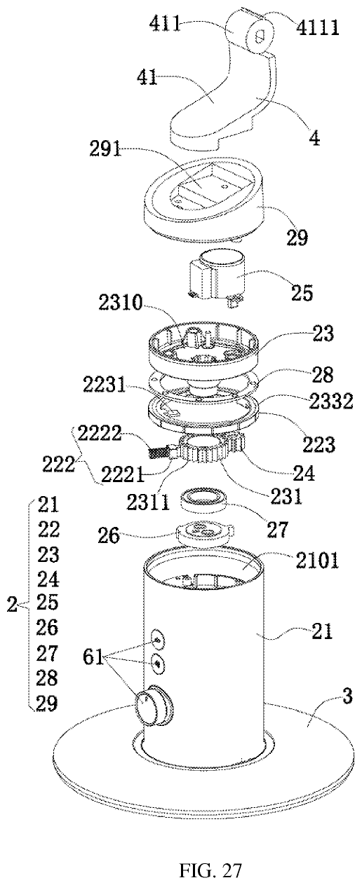

As shown in FIGS. 27 to 29, in an embodiment, the partition member 211 may define a mounting groove 2110. The fixing assembly 22 may include: a central gear 221, a locking member 222, and a fixing ring 223.

Specifically, the central gear 221 may be disposed on a side of the partition member 221 near the rotation bracket 23 and may be meshed with the transmission member 24. The locking member 222 may be received in the mounting groove 2110. A part of the locking member 222 may extend out of the mounting groove 2110 to be mated with the central gear 221, so as to lock the central gear 221. The fixing ring 223 may be fixedly assembled with the partition member 211 and may be configured to limit the locking member 222.

It should be noted that, in the present embodiment, the fixing member 223 and the partition member 211 may be assembled with each other via insertion. The fixing ring 223 may have a blocking portion 2231. The blocking portion 2231 may be configured to close the mounting groove 2110, so as to prevent the locking member 222 from be detached out of the mounting groove 2110 and to ensure the locking member 222 to be used normally.

As shown in FIGS. 27 to 29, in an embodiment, an opening may be defined at a side of the mounting groove 2110 near the central gear 221. The locking member 222 may include: a locking head 2221 and an elastic member 2222. A head end of the locking head 2221 may be capable of extending out of the opening or retracting into the mounting groove 2110. One end of the elastic member 2222 may be connected to a side wall of the mounting groove 2110, and the other end of the elastic member 2222 may be connected to the locking head 2221. The elastic member 2222 may be configured to push the head end of the locking head 2221 out of the opening, so as to lock the central gear 221. In the present embodiment, the elastic member 2222 may be a spring. In other embodiments, the elastic member 2222 may be an elastic sheet, an elastic block, or any other component capable of storing and releasing elastic potential energy.

It should be noted that when the rotation bracket 23 cannot rotate due to an external force, the rotation source 25 may drive the transmission member 24 to rotate to further drive the central gear 221 to rotate. Rotation of the central gear 221 may press the locking head 2221, such that the head end of the locking head 2221 may be retracted into the mounting groove 2110. According to the above configuration, the locking member 222 may not damage the swing component 2 even when the rotation bracket 23 cannot rotate. In this way, damage to the fixing assembly 22 may be avoided, and the rotation source 25 being burnt out due to jamming of the swing component 2 may be prevented, a service life of the swing component 2 may be improved, and user experience may be improved.

As shown in FIGS. 27 to 29, in an embodiment, end surfaces of the central gear 221 that contact the partition plate 211 and the rotation bracket 23 may be respectively arranged with first balls 2211. By arranging the first balls 2211, sliding friction between the central gear 221 and the partition plate 211 and between the central gear 221 and the rotation bracket 23 may be converted into rolling friction. In this way, smoothness of rotation of the central gear 221 may be improved, wear of the central gear 221, the partition plate 211, or the rotation bracket 23 may be avoided, further improving smoothness of usage of the fixing assembly 22 and the service life of the fixing assembly 22.

In the present embodiment, five first balls 2211 may be arranged on the end surface of the central gear 221 that contacts the partition plate 211. Similarly, five first balls 2211 may be arranged on the end surface of the central gear 221 that contacts the rotation bracket 23. It can be understood that the number of first balls 2211 may enable the sliding friction between the central gear 221 and the partition plate 211 and between the central gear 221 and the rotation bracket 23 to be converted into rolling friction.

As shown in FIGS. 23 to 27, in an embodiment, the rotation bracket 23 may include a mounting portion 231 and a shaft portion 232. The mounting portion 231 may be connected to the shaft portion 232. The mounting portion 231 may have a receiving cavity 2310, and a main portion of the rotation source 25 may be mounted in the receiving cavity 2310. The shaft portion 232 may extend away from the mounting portion 231, pass through the central gear 221 and the partition member 211 in sequence, and further extend into the battery compartment 2102.

It should be noted that, in the present embodiment, a through hole may be defined in a bottom of the receiving cavity 2310. A power output shaft of the rotation source 25 may pass through the through hole to be connected to the transmission member 24. The main portion of the rotation source 25 may be fixedly mounted to the bottom of the receiving cavity 2310 by fastening screws.

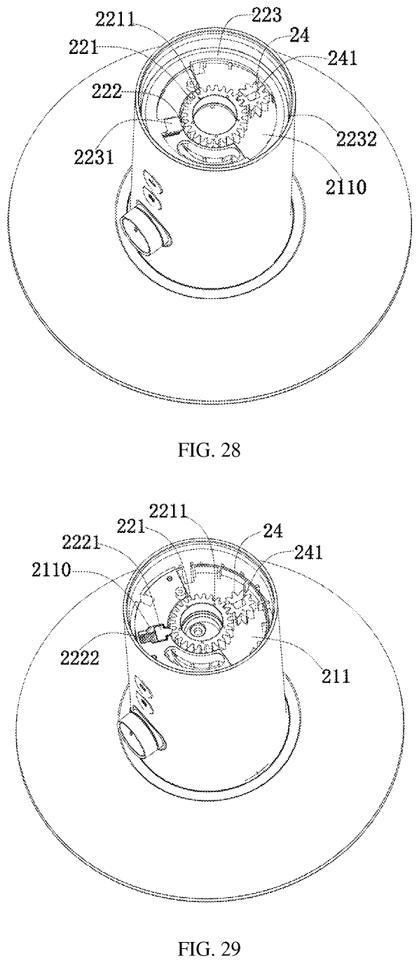

In an embodiment, the transmission member 24 may be a transmission gear, and second balls 241 (as shown in FIG. 28) may be arranged on both an upper end surface and a lower end surface of the transmission member 24 in a circumferential direction. By arranging the second balls 241, sliding friction between the transmission member 24 and the rotation bracket 23 and between the transmission member 24 and the partition member 211 may be converted into rolling friction, such that rotational resistance of the transmission member 24 may be reduced, and the swing component 2 may rotate smoothly and stably.

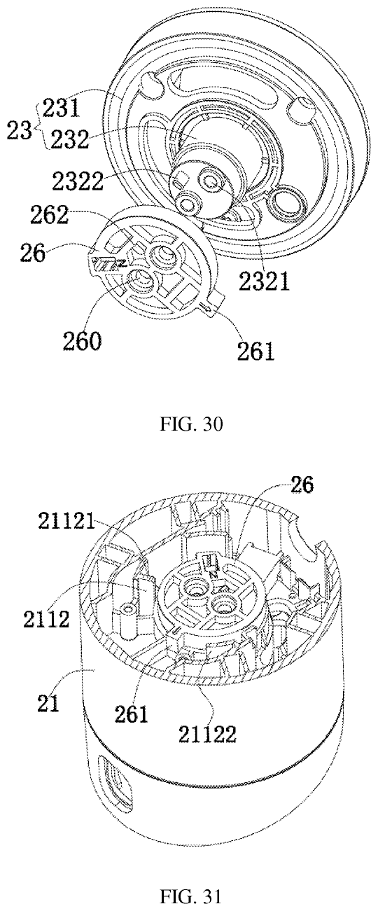

As shown in FIGS. 27, 30, and 31, in an embodiment, a limiting portion 2112 may be arranged on a side of the partition plate 211 away from the fixing assembly 22. The swing component 2 may further include a limiting member 26. The limiting member 26 may be received in the battery compartment 2102 and connected to a side of the shaft portion 232 away from the mounting portion 231. The limiting member 26 may be mated with the limiting portion 2112 to limit a rotation angle of the rotation bracket 23.

In an embodiment, the limiting portion 2112 may include a first limiting end 21121 and a second limiting end 21122. A space between the first limiting end 21121 and the second limiting end 21122 may be a space in which the limiting member 26 can rotate. Specifically, the limiting member 26 may be fixedly connected to the shaft portion 232, such that the limiting member 26 may rotate synchronously with the rotation bracket 23. A limiting protrusion 261 may be arranged on a side wall of the limiting member 26, and the limiting protrusion 261 may be disposed between the first limiting end 21121 and the second limiting end 21122. In this way, the rotation angle of the limiting member 26 may be limited through the limiting portion 2112, and rotation of the rotation bracket 23 may be limited.

In an embodiment, the limiting member 26 may be fixedly assembled to the shaft portion 232 by a fastening screw. Specifically, a threaded hole 2321 may be defined in an end surface of the shaft portion 232 near the limiting member 26. A mounting hole 260 may be defined in the limiting member 26 at a position corresponding to the threaded hole 2321. The fastening screw may pass through the mounting hole 260 and assembled with the threaded hole 2321, such that fixed assembly between the limiting member 26 and the shaft portion 232 may be achieved. In the present embodiment, two fastening screws may be arranged, and correspondingly two threaded holes 2321 and two mounting holes 260 may be defined. In some embodiments, the number of fastening screws may be determined as needed, as long as the fixed assembly between the limiting member 26 and the shaft portion 232 can be achieved.

As shown in FIGS. 27, 30, and 31, in an embodiment, a positioning post 2322 may be further arranged on the end surface of the shaft portion 232 near the limiting member 26. Correspondingly, a positioning hole 262 adapted to the positioning post 2322 may be defined in the limiting member 26. Before the shaft portion 232 and the limiting member 26 are fixed with each other via the fastening screw, the shaft portion 232 and the limiting member 26 may be pre-assembled to each other through the positioning post 2322 and the positioning hole 262, ensuring that the mounting hole 260 may be aligned with the threaded hole 2321. In this way, assembly of the fastening screws may be facilitated, and the fixed assembly between the shaft portion 232 and the limiting member 26 may be facilitated.

It should be noted that, in the present embodiment, a bearing 27 may be arranged between the limiting member 26 and the partition member 211. Specifically, the bearing 27 may be sleeved on the shaft portion 232 and may abut against the end surface of the partition member 211 by the limiting member 26. In this way, tightness of assembly among the rotation bracket 23, the limiting member 26, and the partition member 211 may be ensured; direct contact between the limiting member 26 and the partition member 211 may be prevented, reducing the rotational resistance of the rotation bracket 23 and more effectively ensuring the swing component 2 to rotate stably and smoothly.

In an embodiment, a ball bearing washer 28 may be arranged between the mounting portion 231 and the fixing ring 223. Specifically, the ball bearing washer 28 may include a plurality of balls, and a portion of each of the plurality of balls may be exposed from an upper end surface and a lower end surface of the ball bearing washer 28. In this way, the plurality of balls may abut against the end surface of the mounting portion 231 and the end surface of the fixing ring 223, the sliding friction between the mounting portion 231 and the fixing ring 223 may be converted into rolling friction, the rotational resistance of the rotation bracket 23 may be reduced, and the swing component 2 may rotate stably and smoothly.

It should be noted that, in order to ensure that the plurality of balls can move along a certain trajectory, a first annular groove 2311 may be formed on the end surface of the mounting portion 231 near the fixing ring 223, and a second annular groove 2232 may be formed on the end surface of the fixing ring 223 near the mounting portion 231. Each of the plurality of balls may be partially received in the first annular groove 2311 and partially received in the second annular groove 2232. When the rotation bracket 23 rotates relative to the fixing assembly 22, the plurality of balls may rotate along the first annular groove 2311 and the second annular groove 2232.

In an embodiment, the swing component 2 may further include an end cover 29 connected to the mounting portion 232, and the end cover 29 may be configured to close the receiving cavity 220 and seal the assembly compartment 2101. Specifically, in the present embodiment, three fixing seats may be arranged in the receiving cavity 220, and three threaded posts may be arranged on the end cover 29 at positions corresponding to the three fixing seats. For each of the three fixing seats and a corresponding one of the three threaded posts, a fastening screw may pass through the fixing seat and threadedly engaged with the threaded post, such that the mounting portion 232 and the end cover 29 may be fixed to each other.

In an embodiment, the fan component 1 may be arranged with a hinge portion 11. The connecting assembly 4 may include: a connecting rod 41, a hinge shaft 42, and a blocking cap 43. Specifically, one end of the connecting rod 41 may be fixedly assembled with the end cover 29, and the other end of the connecting rod 41 may be rotatably assembled with the hinge portion 11. The hinge shaft 42 may pass through the connecting rod 41 and the hinge portion 11 to achieve rotatable assembly between the connecting rod 41 and the hinge portion 11. The blocking cap 43 may be connected to the hinge portion 11 and disposed at two ends of the hinge shaft 42. The blocking cap 43 may cover the ends of the hinge shaft 42 assembled with the hinge portion 11, such that overall aesthetics of the connecting assembly 4 may be improved.

In an embodiment, the connecting rod 41 may be substantially L-shaped. An assembly groove 291 may be defined in the end cover 29. A fixed end of the connecting rod 41 may be partially received in the assembly groove 291 and fixed to a bottom of the assembly groove 291 by a fastening screw. A hinge groove (not shown) may be defined in the hinge portion 11. A hinge head 411 may be arranged on a hinge end of the connecting rod 41. When the connecting rod 41 is assembled with the hinge portion 11, the hinge head 411 may be mounted in the hinge groove, and the hinge shaft 42 may pass therethrough to achieve rotatable assembly.

In the present embodiment, a limiting protrusion 4111 may be arranged on an outer side wall of the hinge head 411. Correspondingly, a limiting structure (not shown) adapted to the limiting protrusion 4111 may be arranged in the hinge groove. Mating between the limiting protrusion 4111 and the limiting structure may limit a vertical rotation angle of the fan component 1.

### Embodiment 6

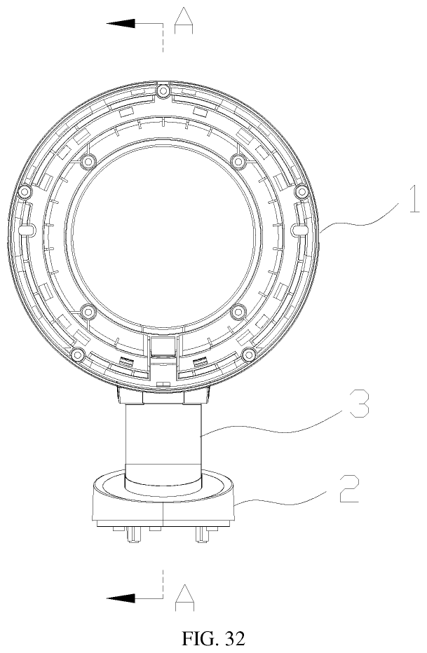

As shown in FIG. 32, an embodiment of the present disclosure may provide a fan connection structure, including: a fan cover 1, a base housing 2, and a bracket 3 for connecting the fan cover 1 and the base housing 2. One end of the bracket 3 may be arranged on the base housing 2, and the other end of the bracket 3 may penetrate from an outer wall of the fan cover 1 near the base housing 2 and rotatably connected to the fan cover 1. A limiting structure for limiting a pitch angle of the fan may be arranged between the bracket 3 and the fan cover 1.

In the above implementation, the fan may include a fan head and a base. The fan head may include the fan cover 1 and a blade assembly. The base may include the base housing 2. The one end of the bracket 3 may be fixedly arranged on the base housing 2, and the other end of the bracket 3 may penetrate from a bottom of the fan cover 1 and rotatably connected to the fan cover 1. In this way, during use, the fan head may rotate to change the pitch angle, with respect to the base. Since a rotation structure may be disposed at the bottom of the fan cover 1, when the fan head is rotated downward, a rear portion of the fan head may not be limited by the base, such that a large downward rotating angle may be achieved, and a large upward rotating angle may also be achieved. By arranging the limiting structure between the bracket 3 and the fan cover 1, the rotation angle of the fan head may be limited, and a maximum rotation angle of the fan head may be 45°. A pitch angle in which the fan head can rotate downwardly may be in a range of 0° to 15°, such that the fan head may not be limited by the base, and horizontal rotation of the fan head may not be affected.

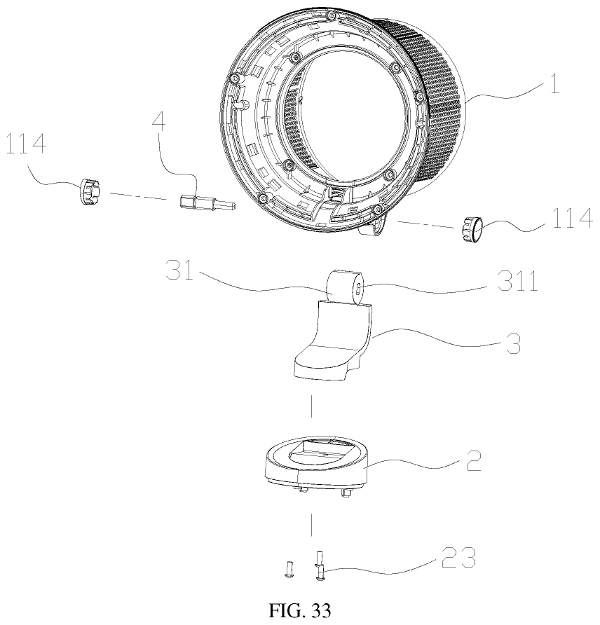

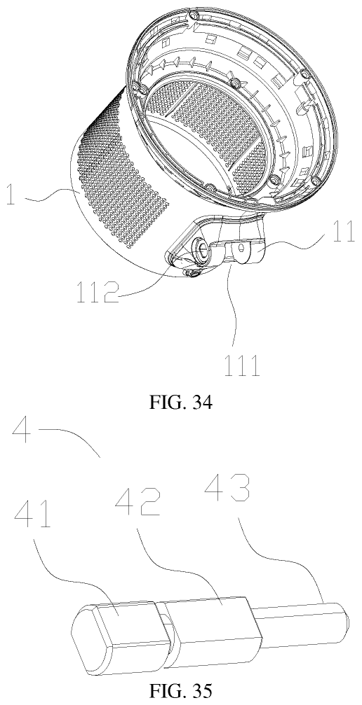

As shown in FIGS. 33 and 34, a surface of the base housing 2 facing the fan cover 1 may be an inclined surface. The end of the bracket 3 facing the base housing 2 may be arranged corresponding to the inclined surface, and the end of the bracket 3 facing the fan cover 1 may extend upward. The end of the bracket 3 facing the fan cover 1 may be arranged with a first connection block 31. The outer wall of the fan cover near the base housing 2 may be arranged with a second connection block 11. The second connection block 11 and the base housing 2 may be integrally formed with each other or separatably connected to each other. The second connection block 11 may be arranged with a first assembly position 111 for receiving the first connection block 31. A connection rotation shaft 4 for mutual mating may be arranged between the first connection block 31 and the second connection block 11.

The bracket 3 may include two sections. One of the two sections facing the base housing 2 may extend inclinedly and downward, and the other one of the two sections facing the fan cover 1 may extend vertically and upward. A large rounded corner may be arranged between the two sections for transition. The first connection block 31 may be a hollow cylindrical block, protruding from a middle of the end of the bracket 3. A recess, i.e., the first assembly position 111, may be defined in a middle of the second connection block 11. After the first connection block 31 is inserted into the first assembly position 111, the connection rotation shaft 4 may be inserted into the first connection block 31 and the second connection block 11, such that rotatable connection between the first connection block 31 and the second connection block 11 may be formed, and the pitch angle of the fan cover 1 with respect to the bracket 3 may be adjusted.

As shown in FIGS. 34 and 35, the second connection block 11 may be arranged with second assembly positions 112, respectively on two sides of the first assembly position 111. The connection rotation shaft 4 may include a fixing portion 41, a mating portion 42, and a movable portion 43 passing through the mating portion 42. The first connection block 31 may define a through hole 311 in which the mating portion 42 may be mounted. The fixing portion 41 may be rotatably connected to the movable portion 43, and the fixing portion 41 and the movable portion 43 may be respectively arranged in the second assembly positions 112. The connection rotation shaft 4 may be a damping rotation shaft.

The movable portion 43 may be integrally formed with the mating portion 42, and the movable portion 43 may be rotatable relative to the fixing portion 41. Two second assembly positions 112 may be arranged. One of the two second assembly positions 112 may have a shape matching the fixing portion 41. The second assembly position 112 may match the fixing portion 41 with a regular or irregular shape, as long as the fixing portion 41 may drive the second assembly position 112 to rotate. The other one of the two second assembly positions 112 may have a shape matching the movable portion 43. A part of the second assembly position 112 that matches the movable portion 43, as well as the movable portion 43 itself, may be cylindrical. The fixing portion 41 may be fixed in the second assembly position 112. The movable portion 43 and the mating portion 42 may be driven by the first connection block 31 to rotate.

Further, by arranging the damping rotation shaft, the fan head of the present disclosure may be held stationary at any angle within a set rotation angle range.

As shown in FIG. 33, an end cap 114 for preventing the connection rotation shaft 4 from being disengaged may be arranged at each of the two second assembly position 112.

Each of two ends of the connection rotation shaft 4 may be sealed by the end cap 114. In this way, the connection rotation shaft 4 may be prevented from being disengaged from the first connection block 31 and the second connection block 11 during use. Furthermore, dust may be prevented from entering the connection rotation shaft 4 and affecting rotation of the connection rotation shaft 4, and an appearance of the two ends of the connection rotation shaft 4 may be improved.

In some embodiments, a vertical cross-section of each of the fixing portion 41, the mating portion 42, and the through hole 311 may be a rounded rectangle in shape; and a vertical cross-section of the movable portion 43 may be circular in shape.

By arranging each of the fixing portion 41 and the mating portion 42 to be the rounded rectangle, during rotation, the fixing portion 41 may be prevented from rotating relative to the second assembly position 112, or the mating portion 42 may be prevented from rotating relative to the first connection block 31.

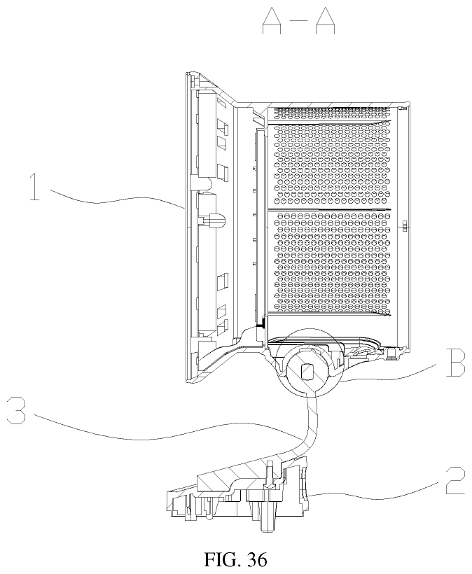

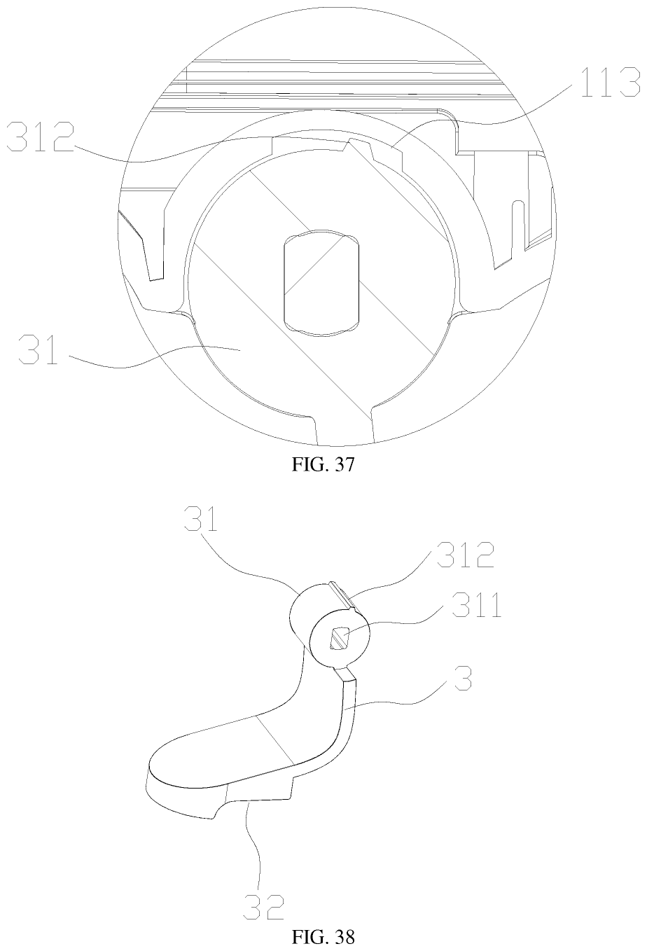

As shown in FIGS. 36 and 37, the limiting structure may include a limiting block 312 arranged on an outer surface of the first connection block 31 and a limiting groove 113 defined in an inner surface of the second connection block 11. The limiting block 312 may be mated with the limiting groove 113.

According to the mating between the limiting block 312 and the limiting groove 113, adjustment of the pitch angle of the fan head may be limited, the pitch angle of the fan head may be prevented from being excessively adjusted, and the fan may be prevented from being unable to blow airflow toward the user.

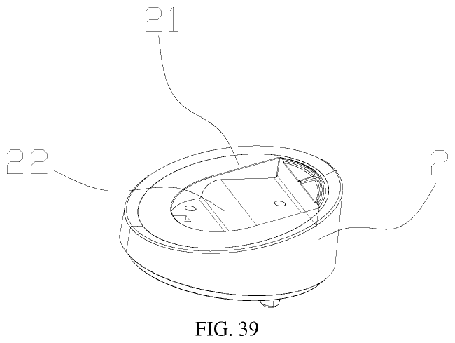

As shown in FIGS. 38 and 39, the surface of the bracket 3 facing the base housing 2 may be arranged with a first step protrusion 32. The surface of the base housing 2 facing the fan cover 1 may define a recess 21. A second step protrusion 22 that is mated with the first step protrusion 32 may be arranged in the recess 21. The first step protrusion 32 and the second step protrusion 22 may be connected to each other by a screw 23.

Since each of the surface of the bracket 3 facing the base housing 2 and the surface of the base housing 2 facing the fan cover 1 may be the inclined surface, by arranging the mated first step protrusion 32 and second step protrusion 22, alignment between the bracket 3 and the base housing 2 may be facilitated, enabling the screw 23 to be assembled vertically, and assembly of the fan may be performed easily. Moreover, the first step protrusion 32 and the second step protrusion 22 may serve as reinforcing ribs, enabling connection between the bracket 3 and the base housing 2 to be more stable. In some implementations, the bracket 3 and the base housing 2 may be connected to each other by snap-fitting, insertion, or any other manner, as long as fixed connection between the bracket 3 and the base housing 2 can be achieved.

In the above implementation, three screws 23 may be arranged. Alternatively, any other number of screws 23 may be arranged, such as 1, 2, 4, 5, 6, and so on, as long as the connection may be stable and economical.

In some implementations, the limiting structure may include a limiting block arranged on the inner surface of the second connection block and a limiting groove defined in the outer surface of the first connection block. The limiting block may be mated with the limiting groove.

Mating between the limiting block and the limiting groove may limit the adjustment of the pitch angle of the fan head, preventing the pitch angle from being excessively adjusted, and the fan may be prevented from being unable to blow airflow toward the user.

### Embodiment 7

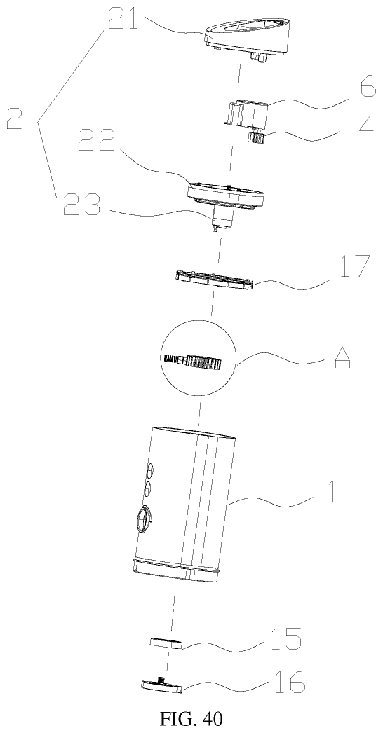

As shown in FIGS. 40 to 42, a fan swing structure may include: a first housing 1 and a second housing 2 rotatable relative to the first housing 1. The first housing 1 may be arranged with a first gear 3 and a rotation feedback member 5 that is capable of elastically resetting relative to a direction of the first gear 3. The second housing 2 may be arranged with a second gear 4 and a drive motor 6 for driving the second gear 4 to rotate. The first gear 3 and the second gear 4 may be meshed to each other. The second gear 4 may rotate around the first gear 3, or the second gear 4 may drive the first gear 3 to rotate around an axis of the first housing 1. The first gear 3 may be coaxial with the first housing 1. The first housing 1 may be the base housing, and the second housing 2 may be the fan head housing. Alternatively, the first housing 1 may be a lower base shell, and the second housing 2 may be an upper base shell. Regardless of which part the first housing 1 and the second housing 2 are, the second housing 2 may always be rotatable relative to the first housing 1, that is, when the second housing 2 rotates relative to the first housing 1, the second housing 2 may drive the fan head to rotate. In the present embodiment, the first housing 1 may be the lower base shell, and the second housing 2 may be the upper base shell. The second housing 2 may be connected to the fan head.

In the above embodiment, the drive motor 6 may be arranged on the second housing 2, and a rotation shaft of the drive motor 6 may be connected to the second gear 4. The second gear 4 has no connection with the first housing 1. The second gear 4 rotating around the first gear 3, or the second gear 4 driving the first gear 3 to rotate around the axis of the first housing 1, may be a transmission mode between the first gear 3 and the second gear 4. In one transmission mode, the first gear 3 does not rotate, and the second gear 4 may rotate around the first gear 3. In another transmission mode, the second gear 4 does not rotate but drives the first gear 3 to rotate. For the one transmission mode, under driving of the drive motor 6, the second gear 4 rotates. In this case, the first gear 3 may be restricted by the rotation feedback member 5 and cannot rotate. Therefore, the second gear 4 may only rotate around the first gear 3, such that the fan may swing. For the another transmission mode, the second housing 2 may rotate under an external force, driving the drive motor 6 and the second gear 4 to rotate together. In this case, the drive motor 6 does not work, and therefore, the second gear 4 does not rotate. An elastic force of the rotation feedback member 5 may be less than the external force. Therefore, due to meshing connection between the first gear 3 and the second gear 4, the second gear 4 may drive the first gear 3 to rotate, such that an airflow output direction of the fan may be adjusted. During a process of adjusting the airflow output direction of the fan, the rotation feedback member 5 may be pressed by the first gear 3 to perform an elastic resetting movement, providing rotational feedback to the user, such that the user may know a current amplitude in which the airflow output direction of the fan is adjusted.

For the above two transmission modes, the one transmission mode may be achieved only when the drive motor 6 is powered on. In this case, the fan head may be driven by the second gear 4 to start rotating reciprocate automatically. The another transmission mode may be achieved regardless of whether the drive motor 6 is powered on. That is, regardless of the fan being swinging or not, the user can manually change the airflow output direction of the fan head, and corresponding rotational feedback may be achieved through the rotation feedback member 5. In this way, the user experience may be improved. The rotational feedback may be a sound generated by the rotation feedback member 5 during operation, that is, as long as the user triggers the rotation feedback member 5 manually, a rotational feedback sound may be emitted.

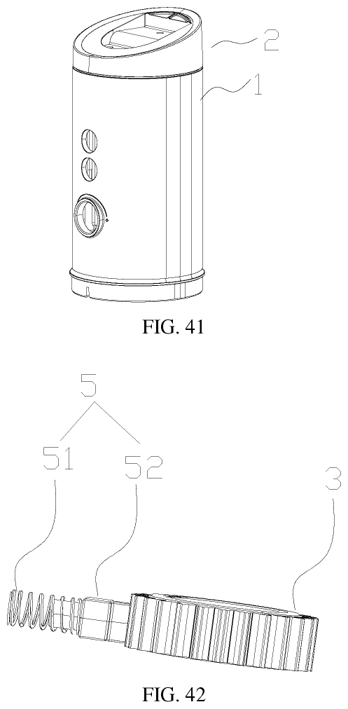

As shown in FIG. 42, the rotation feedback member 5 may include a spring 51 and a latch block 52. One end of the spring 51 may abut against an inner wall of the first housing 1, and the other end of the spring 51 may abut against a surface of the latch block 52 facing away from the first gear 3. The latch block 52 may be embedded in any tooth slot of the first gear 3.

In the above embodiment, when the first gear 3 does not rotate, the spring 51 may not be pressed. When the first gear 3 rotates, the latch block 52 may move from one tooth slot of the first gear 3 to another tooth slot. During the above process, the spring 51 may be pressed and generate an elastic force, pushing the latch block 52 toward the first gear 3. During continuous rotation of the first gear 3, the latch block 52 may move continuously and reciprocately relative to the first gear 3.

In another embodiment, the rotation feedback member 5 may be combination of the spring 51 and a pawl. The pawl may be snapped in the tooth slot of the first gear 3, so as to limit the first gear 3.

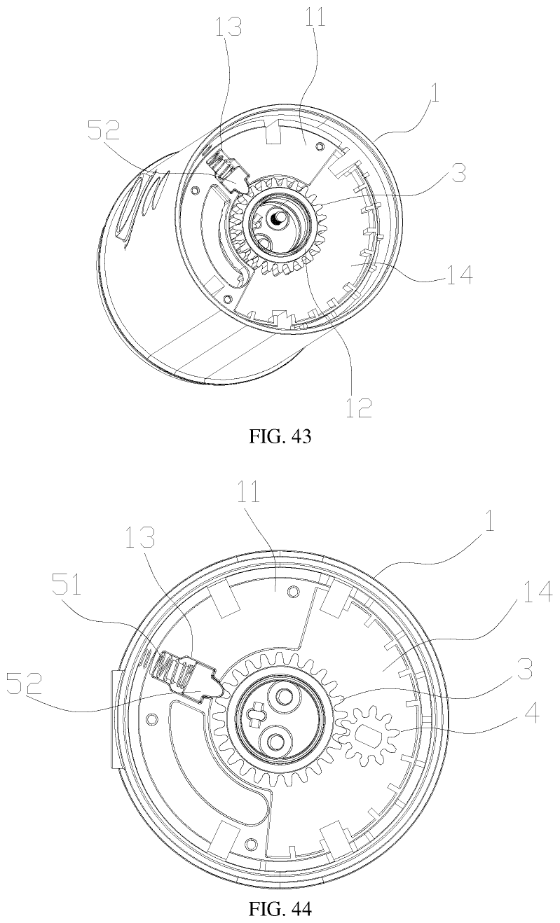

As shown in FIGS. 43 and 44, the first housing 1 may define a groove 13 in which the spring 51 and the latch block 52 may be mounted and a gear movement groove 14 in which the second gear 4 can move. One end of the spring 51 may abut against the inner surface of the groove 13, and the other end of the spring 51 may abut against the surface of the latch block 52 facing away from the first gear 3.

Specifically, the first housing 1 may be arranged with a mounting portion 11. The groove 13 and the gear movement groove 14 may be arranged on a side of the mounting portion 11 facing the second housing 2. In the above embodiment, a part of the mounting portion 11 may be protruding, and the other part may be the gear movement groove 14. The gear movement groove 14 may provide a space for the second gear 4 to move in the mounting portion 11. Although the second gear 4 is arranged in the gear movement groove 14, no connection interference is formed between the second gear 4 and the first housing 1. An outside of the gear installation shaft may define a space for receiving the first gear 3. The groove 13 may be defined in a middle of the protruding part and may be communicated with the space for receiving the first gear 3. A width of the groove 13 may be slightly greater than a maximum width of the latch block 52, such that the latch block 52 may maintain performing the elastic reciprocating movement relative to the first gear 3. The width of the groove 13 may not be excessively large, such that the latch block 52 may not deviate in position during performing the reciprocating movement. Therefore, normal feedback of the latch block 52 may not be affected, and the rotational feedback may be continuously provided to the user when adjusting the airflow output direction of the fan.

As shown in FIGS. 40 and 44, the first housing 1 may be arranged with a shaft sleeve 12 extending toward the second housing 2. An end of the second housing 2 extending toward the first housing 1 may be arranged with a protruding shaft 23 penetrating the shaft sleeve 12. A snap-fit element 16 may be arranged at an end of the protruding shaft 23. The first gear 3 may be sleeved on an outside of the shaft sleeve 12.

Specifically, the mounting portion 11 may be arranged with the shaft sleeve 12. The shaft sleeve 12 may be disposed between the groove 13 and the gear mounting groove. The first gear 3 may be sleeved on the outside of the shaft sleeve 12 and may rotate around the shaft sleeve 12. Since the first gear 3 is coaxial with the first housing 1, the shaft sleeve 12 may be coaxial with the first housing 1. The snap-fit element 16 and the protruding shaft 23 may be detachably connected to each other. The snap-fit element 16 may be disposed on a side of the mounting portion 11 facing away from the second housing 2. After the protruding shaft 23 passes through the shaft sleeve 12, the snap-fit element 16 may be fixedly connected to the protruding shaft 23 by a screw, such that the first housing 1 and the second housing 2 may be relatively fixed to each other in the vertical direction.

As shown in FIG. 46, a limiting block 161 may be arranged on a side surface of the snap-fit element 16. A stop block 111 that is mated with the limiting block 161 may be arranged in the first housing 1. The stop block 111 may extend in a direction away from the second housing 2. Specifically, two limiting blocks 161 may be arranged on the side surface of the snap-fit element 16. Two stop blocks 111 may be arranged. The two limiting blocks 161 and the two stop blocks 111 may not be arranged linearly but in a sector shape. By arranging the limiting blocks 161 mated with the stop blocks 111, an amplitude in which a swing angle and the airflow direction of the fan can be adjusted may be limited.

In an embodiment, a positioning block may be arranged on the protruding shaft 23, and a positioning hole may be defined in the snap-fit element 16. By mating the positioning block with the positioning hole, an operator may be prevented from misassembling the snap-fit element 16 to the protruding shaft 23 in a wrong direction, facilitating assembly of the fan by the operator.

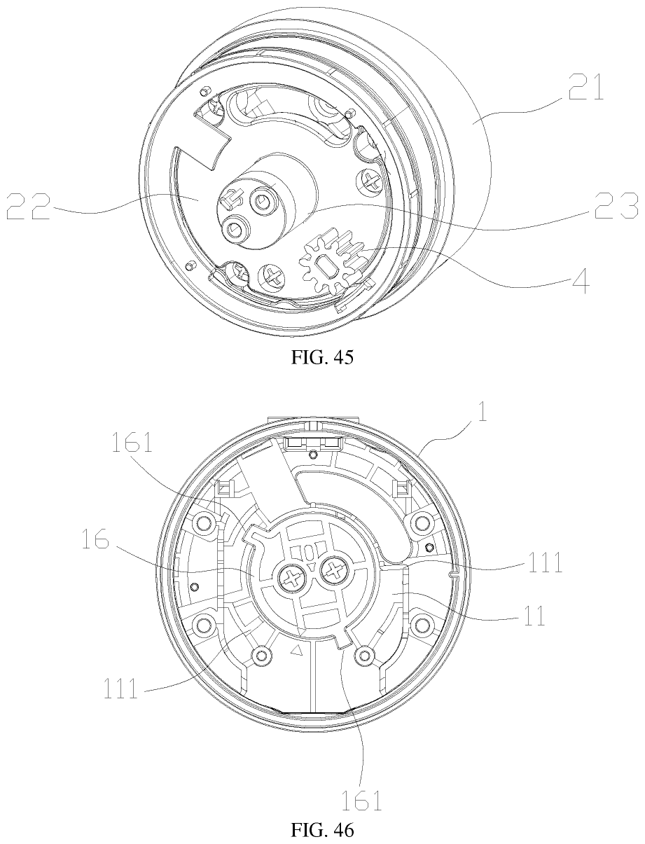

As shown in FIGS. 40 and 45, the second housing 2 may include a first connection portion 21 and a second connection portion 22. The drive motor 6 may be received in a cavity formed by the first connection portion 21 and the second connection portion 22. The rotation shaft of the drive motor 6 may pass through the second connection portion 22 and connected to the second gear 4. The protruding shaft 23 may be arranged on the second connection portion 22.

The drive motor 6 may be received in the cavity formed by the first connection portion 21 and the second connection portion 22. The drive motor 6 may be fixedly connected to the first connection portion 21 by a screw. The second connection portion 22 may be fixedly connected to the first connection portion 21 by a screw. The rotation shaft of the drive motor 6 may pass through the second connection portion 22 and further connected to the second gear 4. A cross section of the rotation shaft of the drive motor 6 may be rounded rectangular in shape. In this way, when the second housing 2 is driven by the external force to rotate, the drive motor 6 and the second gear 4 may rotate together with the second housing 2, to further drive the first gear 3 to rotate, such that the airflow output direction of the fan may be adjusted.

As shown in FIGS. 40, 41, and 48, the protruding shaft 23 and the shaft sleeve 12 may be connected to each other via a first bearing 15.

Specifically, the first bearing 15 may be a rolling bearing, enabling the protruding shaft 23 and the shaft sleeve 12 to be mated to each other more smoothly. Furthermore, the first bearing 15 may enable the protruding shaft 23 to be always in parallel to the axis of the first housing 1.

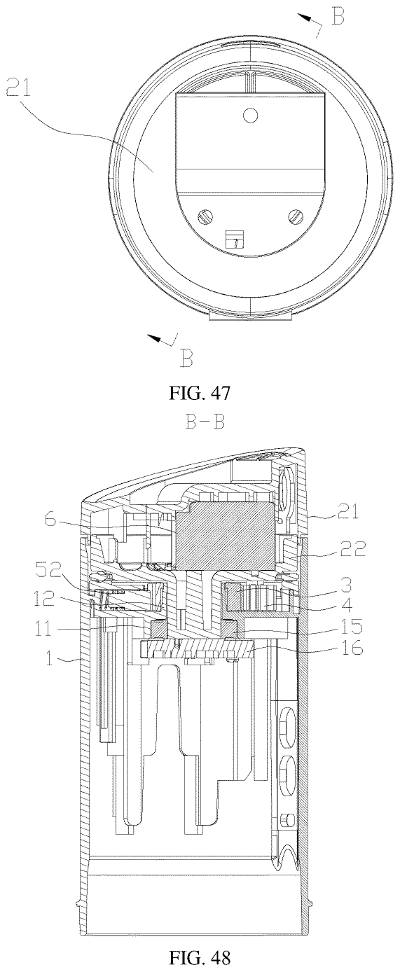

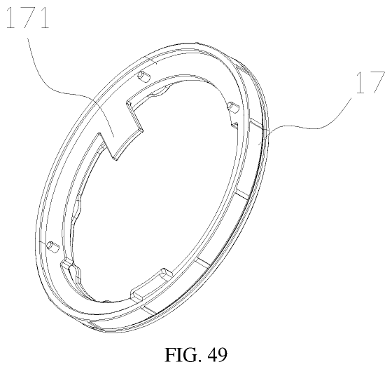

As shown in FIGS. 40 and 47, the first housing 1 and the second housing 2 may be connected to each other via a second bearing 17. A protrusion 171 may be arranged on the second bearing 17. The protrusion 171 may seal an opening of the groove 13.

A plane bearing, i.e., the second bearing 17, may be arranged between the second connection portion 22 and the mounting portion 11, enabling the second connection portion 22 to rotate more conveniently and smoothly. Since the protrusion 171 seals the opening of the groove 13, the spring 51 and the latch block 52 may be prevented from disengaging out of the groove 13.

The fan swing structure in the present embodiment may operate as follows. When the fan needs to swing, the drive motor 6 may start operating to drive the second gear 4 to rotate. At this moment, the first gear 3 may be restricted by the latch block 52 and cannot transmit power from the second gear 4. The first gear 3 does not rotate, and the second gear 4 rotates around the first gear 3, such that the fan can swing. When the airflow output direction of the fan needs to be adjusted, the second housing 2 may need to be twisted. At this moment, the drive motor 6 does not work, the second gear 4 does not rotate, and the second gear 4 may be driven by the second housing 2 to further drive the first gear 3 to rotate around the axis of the first housing 1. That is, the first gear 3 rotates under an action of the second gear 4, such that the airflow output direction of the fan is adjusted. At this moment, the latch block 52 may be pressed by the first gear 3 to compress the spring 51, such that the latch block 52 may perform the elastic resetting movement relative to the first gear 3, providing the rotational feedback to the user.

What is claimed is:

1. A fan module, comprising:
a fan housing, arranged with an air inlet structure and an air outlet corresponding to the air inlet structure;
a fan assembly, arranged inside the fan housing and configured to push an airflow to flow from the air inlet structure toward the air outlet; and
an airflow increasing ring, connected to the fan housing, wherein the airflow increasing ring surrounds and covers the air outlet.

2. The fan module according to claim 1, wherein,
the fan housing is connected to a connecting member, the air outlet is arranged on the connecting member, the fan assembly is connected to the connecting member, and the airflow increasing ring is connected to the connecting member;
and/or
a lamp cover is arranged on the airflow increasing ring, and a light-emitting body is arranged inside the lamp cover.

3. The fan module according to claim 2, wherein,
the airflow increasing ring comprises: a first ring body, an airflow increasing plate, and a plurality of connecting plates; the airflow increasing plate is connected to the connecting member, the plurality of connecting plates are distributed around the airflow increasing plate along a circumferential direction, one end of each of the plurality of connecting plates is connected to the airflow increasing plate, and the other end of each of the plurality of connecting plates is connected to the first ring body.

4. The fan module according to claim 3, wherein, a side of the airflow increasing plate facing the connecting member is recessed inward to form a curved surface; and, along an airflow outputting direction of the air outlet, a width of the first ring body is greater than a width of the airflow increasing plate.

5. The fan module according to claim 2, wherein, the connecting member comprises: a connecting ring, a first cover body, and a plurality of airflow guide plates; the connecting ring is connected to an inner surface of the fan housing, the plurality of airflow guide plates are distributed around the first cover body along a circumferential direction; one end of each of the plurality of airflow guide plates is connected to the first cover body, the other end of each of the plurality of airflow guide plates is connected to the connecting ring, the fan assembly is connected to the first cover body, the connecting ring and the first cover body cooperatively define the air outlet, and the air outlet is annular.

6. The fan module according to claim 5, wherein,
in a direction extending from the air outlet toward the air inlet structure, each of the plurality of airflow guide plates extends in a curved manner along a surface of the first cover body, and a curved direction of each of the airflow guide plates is opposite to a rotation direction of the fan assembly during rotation;
and/or
a side of the first cover body facing the airflow increasing ring is protruding to form a connection plate, a side of the connection plate facing the fan assembly is arranged with a connection post, and the fan assembly is connected to the connection post;
and/or
along the direction of the air outlet, a distance between the first cover body and the fan housing gradually decreases, a distance between the first cover body and the connecting ring gradually decreases, and a width of each of the airflow guide plates gradually decreases.

7. The fan module according to claim 6, wherein, a side of the connection plate facing the fan assembly is recessed inward to form a receiving ring, the receiving ring surrounds the connection post, and at least part of the fan assembly extends into the receiving ring.

8. The fan module according to claim 2, wherein, the fan housing comprises: a first housing and an airflow guide cover; the first housing is connected to the airflow guide cover, the connecting member is connected to the airflow guide cover, the fan assembly extends into the airflow guide cover, the airflow guide cover is arranged with a constricted port, and the fan assembly is disposed between the constricted port and the connecting member.

9. The fan module according to claim 8, wherein, the air inlet structure comprises a plurality of air inlet holes, the plurality of air inlet holes are defined in the first housing, a filter assembly is arranged in the first housing, and the filter assembly covers the plurality of air inlet holes; or
a gap is formed between the first housing and an end of the airflow guide cover facing away from the connecting member, a reinforcing rib is arranged in the gap, one end of the reinforcing rib is connected to the first housing, the other end of the reinforcing rib is connected to the airflow guide cover, and one end of the filter assembly is inserted into the gap and connected to the reinforcing rib.

10. The fan module according to claim 9, wherein, the filter assembly comprises: a first mounting ring, a second mounting ring, a filter ring, and a filter sheet; the filter ring is connected to the first mounting ring and the second mounting ring, the filter sheet is connected to the first mounting ring, the second mounting ring is received in the gap and connected to the reinforcing rib, and the first mounting ring is connected to a bottom surface of the first housing.

11. The fan module according to claim 10, wherein, the first mounting ring defines a first mounting groove and an annular storage cavity, the first mounting groove surrounds the annular storage cavity, the second mounting ring defines a second mounting groove, one end of the filter ring is inserted into the first mounting groove, the other end of the filter ring is inserted into the second mounting groove, and the filter sheet is received in the annular storage cavity.

12. The fan module according to claim 1, wherein, the fan assembly comprises fan blade assembly, the fan blade assembly comprises:
a hub connected to a fan motor; and
a plurality of blades, arranged on an outer surface of the hub along a circumferential direction of the hub;
wherein each of the plurality of blades extends curvedly along a surface of the hub from a top end portion of the hub toward a side edge portion of the hub, and each of the plurality of blades is twisted.

13. The fan module according to claim 12, wherein, the hub is configured to be conical or truncated conical.

14. The fan module according to claim 12, wherein,
each of the plurality of blades comprises a blade tip, a facing direction of the blade tip is the same as a rotation direction of the fan blade assembly;
and/or
each of the plurality of blades comprises a blade tip, an angle between an extension line of a pointing direction of the blade tip and a horizontal direction is an acute angle.

15. The fan module according to claim 14, wherein, an airflow-cutting inclined surface is arranged at the blade tip, and the airflow-cutting inclined surface extends in a direction opposite to the rotation direction of the fan blade assembly.

16. The fan module according to claim 15, wherein,
an angle between the blade tip and a blade edge is an acute angle;
and/or
each of the plurality of blades comprises a blade tail, the blade tail extends curvedly in a direction opposite to the rotation direction of the fan blade assembly.

17. The fan module according to claim 16, wherein,
the airflow-cutting inclined surface comprises: a curved portion and a linear portion; one end of the linear portion is connected to a surface of the hub, the other end of the linear portion is connected to the curved portion, and the other end of the curved portion is connected to the blade edge;
and/or
a length of the blade tip is greater than a length of the blade tail;
and/or
at least one curved notch is formed at the blade tail.

18. The fan module according to claim 17, wherein, a connection position between the curved portion and the blade edge is configured to be an acute angle.

19. The fan module according to claim 17, wherein, when two or more curved notches are formed at the blade tail, a curved protrusion is formed between every two adjacent ones of the two or more curved notches, and a curved direction of the curved protrusion is opposite to a curved direction of each of the two or more curved notches.

20. The fan module according to claim 17, wherein, when two or more curved notches are formed at the blade tail, in a direction extending from the hub toward the blade edge, an area of each of the two or more curved notches gradually decreases.
